(19) United States
(12) Patent Application Publication
(10) Pub. No.: US 2025/0177929 A1
(43) Pub. Date: Jun. 5, 2025

(54) MANUFACTURING METHOD AND MANUFACTURING DEVICE FOR LIQUID CONTAINING FINE BUBBLES

(71) Applicant: CANON KABUSHIKI KAISHA, Tokyo (JP)

(72) Inventors: TAKAHARU AOTANI, London (GB); IKUO NAKAZAWA, Kanagawa (JP)

(21) Appl. No.: 19/047,149

(22) Filed: Feb. 6, 2025

Related U.S. Application Data
(63) Continuation of application No. PCT/JP2023/027042, filed on Jul. 24, 2023.

(30) Foreign Application Priority Data
Aug. 10, 2022 (JP) 2022-128243
Jun. 27, 2023 (JP) 2023-105067

(51) Int. Cl. B01F 23/2375; B01F 23/213; B01F 23/23; B01F 23/237

(52) U.S. Cl. CPC B01F 23/2375; B01F 23/2133; B01F 23/237613; B01F 23/238

(57) ABSTRACT

One embodiment of the present disclosure is a manufacturing method for a liquid containing fine bubbles, comprising: a generation step of generating liquid droplets containing fine bubbles by atomizing a liquid through irradiation with an ultrasonic wave; and a recovery step of recovering the liquid droplets into a recovery container by using a recovery mechanism including the recovery container.

### CROSS-REFERENCE TO RELATED APPLICATIONS

This application is a Continuation of International Patent Application No. PCT/JP2023/027042, filed Jul. 24, 2023, which claims the benefit of Japanese Patent Application No. 2022-128243, filed Aug. 10, 2022 and Japanese Patent Application No. 2023-105067, filed Jun. 27, 2023, both of which are hereby incorporated by reference herein in their entirety.

### BACKGROUND

### Field

The present disclosure relates to a manufacturing method and a manufacturing device for a liquid containing fine bubbles.

### Background Art

In recent years, techniques for applying properties of minute bubbles such as microbubbles having a diameter of micrometer size and nanobubbles having a diameter of nanometer size have been under development. In particular, bubbles having a diameter of 100 μm or less are defined as fine bubbles, bubbles having a diameter of 1.0 μm to 100 μm are defined as microbubbles, and bubbles having a diameter of 1.0 μm or less are defined as ultra fine bubbles (UFB), and various useful properties of these fine bubbles have been confirmed.

PTLs listed below disclose techniques for generating fine bubbles and techniques for manufacturing a liquid containing fine bubbles. In these PTLs, after a desired gas is dissolved in a liquid, the gas thus dissolved is precipitated by a dissolution-precipitation method to manufacture a liquid containing ultra fine bubbles, and in a step of obtaining a gas-dissolved water, bubbling or the like is generally used.

However, in the manufacturing methods of the above-described PTLs, much of a gas loaded flows out to the atmosphere without being dissolved in a liquid. In addition, in a case where a method for reducing the size of bubbles of a desired gas in a liquid (such as a swirling flow method) is used, millibubbles and microbubbles present in a mixed manner float up or disappear to flow out to a gas layer. For this reason, there is a case where much of a gas flows out to the gas phase side and is wasted. In addition, the manufacturing methods described in the above-described PTLs require a large amount of a gas as a raw material, and in turn require a gas cylinder and the like.

In view of the above-described problem, an object of the present disclosure is to provide a technique for effectively manufacturing a liquid containing fine bubbles.

### SUMMARY

One embodiment of the present disclosure is a manufacturing method for a liquid containing fine bubbles, comprising a generation step of generating liquid droplets containing fine bubbles by atomizing a liquid through irradiation with an ultrasonic wave; and a recovery step of recovering the liquid droplets into a recovery container by using a recovery mechanism including the recovery container.

Further characteristics of the present disclosure will be clarified from the descriptions of the following embodiments made by referring to the attached drawings.

### BRIEF DESCRIPTION OF DRAWINGS

FIG. 1A is diagrams for explaining a manufacturing method for a liquid containing fine bubbles.

FIG. 1B is diagrams for explaining a manufacturing method for a liquid containing fine bubbles.

FIG. 1C is diagrams for explaining a manufacturing method for a liquid containing fine bubbles.

FIG. 2 is a diagram showing a state before the liquid containing fine bubbles is manufactured.

FIG. 3 is a diagram showing a state during manufacture of the liquid containing fine bubbles.

FIG. 4A is diagrams showing a state where the manufacture of the liquid containing fine bubbles is completed.

FIG. 4B is diagrams showing a state where the manufacture of the liquid containing fine bubbles is completed.

FIG. 5 is a diagram showing one example of a manufacturing device for a liquid containing fine bubbles.

FIG. 6 is a diagram showing a state during manufacture of a liquid containing fine bubbles.

FIG. 7A is diagrams showing a state where the manufacture of the liquid containing fine bubbles is completed.

FIG. 7B is diagrams showing a state where the manufacture of the liquid containing fine bubbles is completed.

FIG. 8 is a diagram showing one example of a manufacturing device for a liquid containing fine bubbles.

FIG. 9 is a diagram showing one example of a manufacturing device for a liquid containing fine bubbles.

FIG. 10 is a diagram showing one example of a manufacturing device for a liquid containing fine bubbles.

FIG. 11 is a diagram showing one example of a manufacturing device for a liquid containing fine bubbles.

FIG. 12 is a diagram showing one example of a manufacturing device for a liquid containing fine bubbles.

FIG. 13 is a diagram showing one example of a manufacturing device for a liquid containing fine bubbles.

FIG. 14 is a diagram showing one example of a manufacturing device for a liquid containing fine bubbles.

FIG. 15 is a diagram showing one example of a manufacturing device for a liquid containing fine bubbles.

FIG. 16 is a diagram showing a usage example in which a recovery mechanism for liquid containing fine bubbles is inclined.

FIG. 17 is a diagram showing a recovery mechanism a wall of which has flexibility.

FIG. 18 is a diagram showing one example of a manufacturing device for a liquid containing fine bubbles.

FIG. 19 is a diagram showing one example of a manufacturing device for a liquid containing fine bubbles.

FIG. 20 is a diagram showing one example of a manufacturing device for a liquid containing fine bubbles which indirectly conducts piezoelectric atomization.

FIG. 21 is a diagram showing one example of a manufacturing device for a liquid containing fine bubbles which indirectly conducts piezoelectric atomization.

FIG. 22 is a diagram showing one example of a manufacturing device for a liquid containing fine bubbles which is covered with a recovery container.

FIG. 23 is a diagram showing one example of a manufacturing device for a liquid containing fine bubbles which includes a plurality of vibrators (atomized FB generating devices) which emit an ultrasonic wave.

FIG. 24A is diagrams for explaining a manufacturing method for a liquid containing fine bubbles.

FIG. 24B is diagrams for explaining a manufacturing method for a liquid containing fine bubbles.

FIG. 25 is a diagram showing a state before the liquid containing fine bubbles is manufactured.

FIG. 26 is a diagram showing a state during manufacture of the liquid containing fine bubbles.

FIG. 27 is a diagram showing a state where the manufacture of the liquid containing fine bubbles is completed.

FIG. 28 is a diagram showing one example of a manufacturing device for a liquid containing fine bubbles.

FIG. 29 is a diagram showing one example of a manufacturing device for a liquid containing fine bubbles.

FIG. 30 is a diagram showing one example of a manufacturing device for a liquid containing fine bubbles.

FIG. 31 is a diagram showing one example of a manufacturing device for a liquid containing fine bubbles.

FIG. 32 is a diagram showing one example of a manufacturing device for a liquid containing fine bubbles.

FIG. 33 is a diagram showing one example of a manufacturing device for a liquid containing fine bubbles.

FIG. 34 is a diagram showing one example of a manufacturing device for a liquid containing fine bubbles which includes a plurality of vibrators (atomized FB generating devices) which emit an ultrasonic wave.

### DESCRIPTION OF EMBODIMENTS

Hereinafter, embodiments according to the present disclosure will be described. Note that the following embodiments are illustrative, and are not intended to limit the spirit of the present disclosure more than necessary. As used herein, fine bubbles (FB) mean small bubbles composed of a gas. In addition, a liquid containing fine bubbles means a liquid containing fine bubbles, which are small bubbles. It is also assumed that the gas of the fine bubbles is composed of one component or a plurality of components, and the proportion of a gas component can also be adjusted by controlling the gas component in a recovery mechanism for the liquid containing fine bubbles. A desired gas component may be present as fine bubbles in a liquid or may be present in a state of being dissolved in a liquid.

### <Overview of Manufacture of Liquid Containing Fine Bubbles>

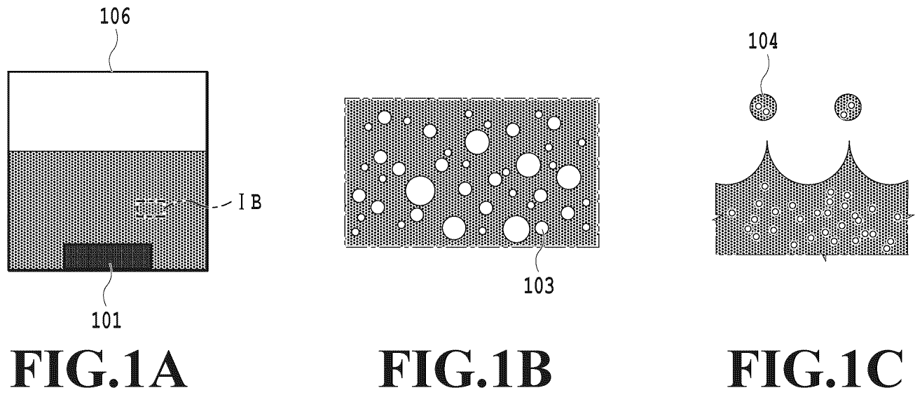

Hereinafter, a method for Manufacturing a liquid containing fine bubbles by irradiating a liquid with an ultrasonic wave will be described by using FIG. 1A, FIG. 1B, and FIG. 1C. FIG. 1A shows an overview of a device for manufacturing a liquid containing fine bubbles by irradiating a liquid with an ultrasonic wave. FIG. 1B is a diagram extracting a region Ib in FIG. 1A, and shows an assumption diagram in the liquid irradiated with the ultrasonic wave. FIG. 1C shows a surface wave formed in a process of manufacturing the liquid containing fine bubbles.

As shown in FIG. 1A, since a liquid is irradiated with an ultrasonic wave from inside by an atomized FB generating device 101 which generates fine bubbles by atomizing the liquid, the molecules vibrate in the liquid in a propagation direction of sound, so that high-pressure and low-pressure regions are alternately generated. In the low-pressure region, the pressure of the molecules of the liquid becomes lower than the vapor pressure, and fine bubbles 103 which are small bubbles of the dissolved gas are generated as shown in FIG. 1B. Regarding the fine bubbles generated in the liquid, there are bubbles that are formed by association of fine bubbles and released to the outside of the liquid by repetition of expansion and contraction due to influence of the ultrasonic wave. In addition, there are fine bubbles that are broken with pressure by vibration due to the influence of the ultrasonic wave. For this reason, it is considered that small fine bubbles are relatively likely to remain in the liquid.

The reason why the atomization phenomenon occurs in a gas-liquid interface is considered to be that as shown in FIG. 1C, a surface wave is formed, and when the vibration amplitude of the surface wave exceeds the critical point, any crest is broken to generate small droplets, causing atomization. The “atomization” mentioned here indicates generation of fine bubble-containing liquid droplets 104 which are a fine mist liquid.

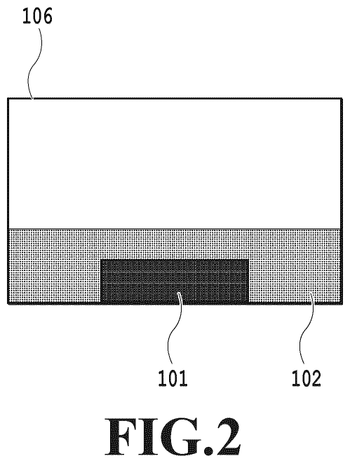

In the case of conducting atomization in a gas-liquid interface, the effect that relaxation of the pressure occurs is made significant by atomizing a liquid containing fine bubbles and simultaneously generating liquid droplets. For this reason, fine bubbles are newly generated at the time of atomization, and liquid droplets containing the fine bubbles thus generated are generated. In the case where the liquid droplets thus atomized are small, since large fine bubbles cannot exist in the liquid droplets, as a result, ultra fine bubbles (abbreviated to UFB), which are small fine bubbles, are selectively generated. Thereafter, a liquid containing fine bubbles can be manufactured by recovering the liquid droplets containing the fine bubbles. Note that in the case of employing a configuration shown in FIG. 2, since a recovery container 106 is sealed and the entire device is covered, liquid droplets containing fine bubbles can be generated by irradiating a liquid with an ultrasonic wave, and the liquid droplets thus generated can be recovered as a liquid containing fine bubbles without leaking to the outside.

As a mode for atomizing a liquid by irradiating the liquid with an ultrasonic wave, it is preferable that the thickness of the liquid provided on a vibrator be 15 cm or less, depending on the output and the intensity of the vibrator used to irradiate the liquid with the ultrasonic wave, though. In the case where the thickness of the liquid exceeds 15 cm, since the intensity of irradiation of the ultrasonic wave for atomization increases, there is a concern about influence on a liquid medium. In the case where water is given as a specific example of the liquid, there is a concern that the water molecules turn into hydroxyl radicals, which react with, for example, dissolved nitrogen, which is an atmospheric component, to generate nitrogen oxide ions.

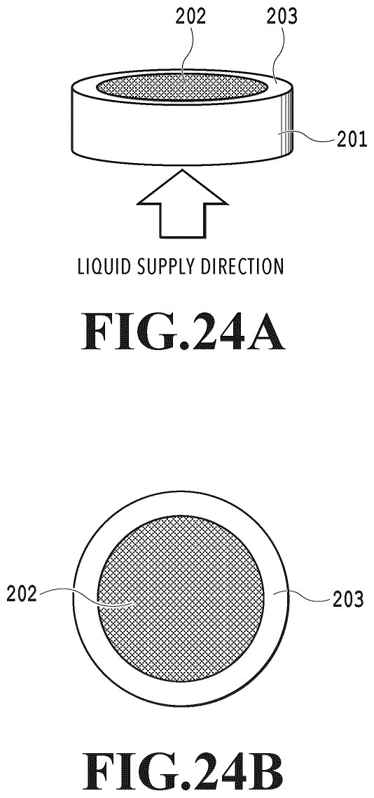

Note that the method for manufacturing a liquid containing fine bubbles by applying an ultrasonic vibration is not limited to the above-mentioned method. Here, a method different from the above-mentioned method will be described by using FIG. 24A and FIG. 24 B. FIG. 24A is a perspective view of an atomized FB generating device 201 which generates fine bubbles by using vibration caused by influence of an ultrasonic wave, and FIG. 24B is a top view of the atomized FB generating device 201. As shown in FIG. 24A, a mesh 202, which is fine holes, is present in a center portion of an upper surface of the atomized FB generating device 201, which has a cylindrical shape. These holes penetrate from the bottom surface side of the atomized FB generating device 201, and a liquid is supplied from the bottom surface side by capillary force or the like. Applying an ultrasonic vibration of a vibrator 203, which is provided on a peripheral portion of the mesh 202, to the supplied liquid generates fine liquid droplets (so-called atomization). It is considered that in this event, a dissolved gas contained in the liquid turns into fine bubbles, which are small bubbles, by an abrupt change in pressure due to ultrasonic vibration. In addition, it is also considered that at the same time, in turning into fine liquid droplets (being atomized), the liquid takes in the gas in the space, so that fine bubbles are generated.

In order to prevent the fine bubbles from being released and diffused to the outside of the liquid in recovery, diffusing preventing effect can be expected by setting an average value of relative humidity derived from the component of the liquid droplets in the space to 80% or more. In the case where this average value is less than 80%, the liquid droplets containing the fine bubbles are evaporated, so that only a small amount of the liquid can be recovered, leading to a problem of a decrease in recovery amount. In addition, in the case where the weight ratio of the liquid containing fine bubbles to the raw material liquid of the liquid containing fine bubbles is less than 80%, there is a concern that the atomized liquid droplets flow out of the manufacturing device, leading to a problem of a decrease in yield.

As the gas in the recovery mechanism, air in an installation environment of the manufacturing device may be used unless otherwise specified; however, the gas is not limited to air. Possible other gases in the recovery mechanism include oxygen, nitrogen, hydrogen, ozone, helium, carbon dioxide, methane, ethane, propane, butane, chlorine, chlorine dioxide, and the like, and mixed gases of these. In addition, dry air (air obtained by removing a water content from the aforementioned air) and clean dry air (air obtained by removing particles from the aforementioned dry air) are also preferable. Note that clean dry air can be obtained by using a recovery mechanism in which a dust filter, a mist filter, a heater for removing a water content, and the like are inserted. A chemical filter may be mounted on such a recovery mechanism.

In the case of using an ozone-containing gas as the gas in the recovery mechanism, although there is no particular limitation, it is preferable that an ozone gas generating unit which produces an ozone gas through an electric discharge system or ultraviolet ray irradiation be provided in the recovery mechanism to create an ozone-containing atmosphere inside the recovery mechanism. Creating an ozone-containing atmosphere is preferable because a risk of generating nitrogen oxide is reduced in the case of producing an ozone gas through an ultraviolet ray irradiation in the atmosphere. As a light source, a light source which is capable of emitting light having an absorption wavelength of oxygen molecules is preferable, a light source which is capable of emitting light having a wavelength of 240 nm or less is further preferable, and a publicly-known light source can also be used. For example, a low-pressure mercury light using quartz for a glass is representative, a similar effect can be obtained by using a recent mercury-free ozone light as well. Specifically, such a light includes an excimer light, CARE222 (manufactured by Ushio, Inc.) and the like. Of course, in order to use light having these wavelengths without blocking, a transmissive material such as a quartz glass may be used as a member to be used in an optical path.

In addition, in the case of quenching ozone in the recovery mechanism at the stage where the manufacture of ozone gas-containing fine-bubble water is completed, it is possible to use a publicly-known chemical method such as utilizing a manganese-based catalyst, activated carbon, or the like. However, it is also a preferable mode to cause a general-purpose sterilization light capable of emitting light having a wavelength of 254 nm, which is an absorption wavelength of ozone, to emit light in the recovery mechanism for deactivation.

Note that as a liquid-contact member for an ozone-containing UFB liquid after ultraviolet ray irradiation, it is preferable to use a material having a resistance to ozone. As a material having a resistance to ozone, it is preferable to use titanium as a metal, a fluorine-based polymer (PFA, PTFE, or the like) as a resin, quartz as a glass, or the like.

The liquid to be atomized by irradiation with an ultrasonic wave is not particularly limited and may be water, an organic liquid, an ionic liquid, or the like, but water is preferable. Means for supplying a liquid to be atomized by irradiation with an ultrasonic wave is not particularly limited. For example, in the case of employing water as a liquid to be atomized, water may be supplied to a tank in a batch system, or water may be supplied through a pipe from water pipes, or a water content in the atmosphere may be supplied as condensed water using a Peltier element or the like. By shaking and agitating a liquid to be irradiated with an ultrasonic wave to be atomized under a desired gas atmosphere, water in which the desired gas is dissolved is generated in accordance with the Henry's law. Under an oxygen atmosphere, an oxygen-containing water of 45 ppm can be obtained. On the other hand, under the ambient atmosphere, water in which oxygen of about 8.4 ppm is dissolved can be generated at room temperature.

The water includes water purified to have high purity (ultra-pure water), tap water, and hard water. In addition, the water may contain a solute dissolved therein (an electrolyte formed by dissociation of sodium chloride, silver nitrate, or the like, free chlorine, an amino acid, a saccharide, a buffering agent, a dye, or the like) or the like, and also may contain a dispersion (a pigment, a dispersant, cells, bubbles, an emulsion, titanium oxide, an emulsifier, or the like) or the like.

In addition, a mixed liquid of water and an organic liquid can also be used. The water-soluble organic solvent to be used is not particularly limited, but specific examples thereof include the followings: alkyl alcohols having 1 to 4 carbon atoms such as methyl alcohol, ethyl alcohol, n-propyl alcohol, isopropyl alcohol, n-butyl alcohol, sec-butyl alcohol, and tert-butyl alcohol, amides such as N-methyl-2-pyrrolidone, 2-pyrrolidone, 1,3-dimethyl-2-imidazolidinone, N,N-dimethylformamide, and N,N-dimethylacetamide, ketones or ketols such as acetone and diacetone alcohol, and cyclic ethers such as tetrahydrofuran and dioxane, ethylene glycol, 1,2-propylene glycol, and 1,3-propylene glycol.

1,2-butanediol, 1,3-butanediol, and 1,4-butanediol. In addition, glycols such as 1,5-pentanediol, 1,2-hexanediol, 1,6-hexanediol, 3-methyl-1,5-pentanediol, diethylene glycol, triethylene glycol, and thiodiglycol.

Ethylene glycol monomethyl ether, ethylene glycol monoethyl ether, ethylene glycol monobutyl ether, diethylene glycol monomethyl ether, diethyleneglycol monoethyl ether, and diethylene glycol monobutyl ether. In addition, lower alkyl ethers of polyalcohols such as triethylene glycol monomethyl ether, triethylene glycol monoethyl ether, and triethylene glycol monobutyl ether.

Polyalkylene glycols such as polyethylene glycol and polypropylene glycol. Triols such as glycerin, 1,2,6-hexanetriol, and trimethylolpropane.

Note that the water-soluble organic solvents listed above may be used alone or two or more of these may be used in combination. In addition, as the liquid for the gas solution, a liquid derived from a living organism, specifically a blood, a spinal fluid, or the like can also be used.

An ultrasonic wave irradiation unit for atomization is not particularly limited, but a piezoelectric material is preferable. Piezoelectric materials are widely used in applications of an actuator, a vibrator for emitting an ultrasonic wave, a micropower source, a high-voltage generating device, and the like. Many piezoelectric substances used in these are materials so-called PZT, and are oxides containing lead (Pb), zirconium (Zr), and titanium (Ti). For this reason, the development of lead-free piezoelectric materials has been in progress from the viewpoint of environmental issues.

The lead-free piezoelectric material includes a Ba-based perovskite oxide expressed by a general formula BaM′O3, for example. Although M′ represents an element of one type or a crystalline mixture of two or more elements in a certain composition ratio, it is necessary to satisfy that the charge of the general formula BaM′O3 becomes neutral. A piezoelectric material represented by BaM′O3 includes BaTiO3, which takes tetragonal structure at near-room temperature, for example.

As the ultrasonic wave irradiation unit, a commercially-available unit can be used. For example, such a unit includes an immersion-type ultrasonic wave atomization unit IM1-24 manufactured by SEIKO GIKEN INC., a cordless aroma diffuser MJ-CAD1 44486320 of Ryohin Keikaku Co., Ltd., which is commercially available as a humidifier, and the like, but is not limited to these. As an ultrasonic wave atomization generating device as a commercial product, a nebulizer and the like are also preferable examples. In addition, a mode in which a liquid to be a raw material of a liquid containing fine bubbles and a liquid phase in which a piezoelectric atomization unit which emits an ultrasonic wave are separated, and the liquid is indirectly atomized piezoelectrically is also preferable. The liquid phase in which a piezoelectric atomization unit for emitting an ultrasonic wave is not particularly limited, but QUAVA mini manufactured by KAIJO corporation, and the like are preferable. In addition, the vibrator frequency is not particularly limited, but is preferably 1.6 MHz.

In addition, as one example for improving acid resistance, alkali resistance, solvent resistance, corrosion resistance (like an ozone water), it is also preferable to cover a liquid-contact member of a piezoelectric element with a fluorine-based resin, a titanium-based member, a glass member such as quartz.

### <Manufacture of Liquid Containing Fine Bubbles>

Hereinafter, the flow of manufacturing a liquid containing fine bubbles by using the manufacturing device having the configuration shown in FIG. 1A will be described.

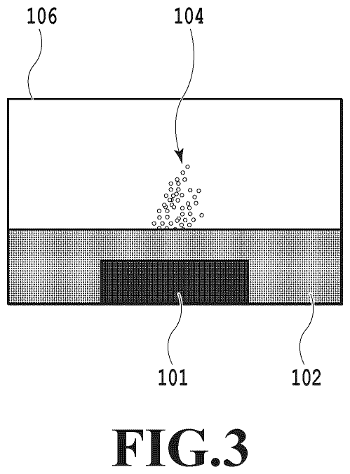

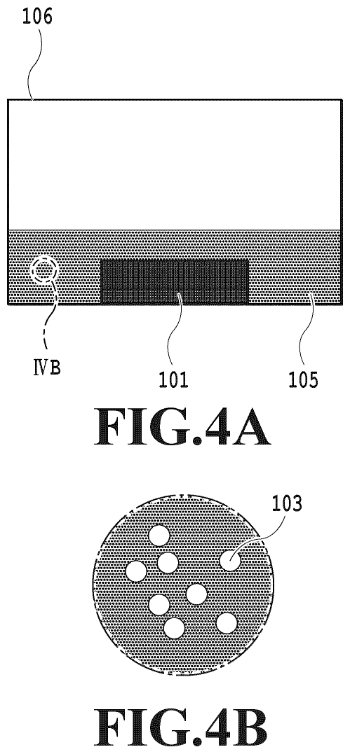

FIG. 2 shows a state before the manufacturing device starts operation. By energizing the atomized FB generating device 101 in this state, the ultrasonic vibration is started, and applying the ultrasonic vibration to the liquid generates a liquid column to cause atomization as shown in FIG. 3, so that liquid droplets of the liquid containing fine bubbles float and diffuse. Thereafter, as shown in FIG. 4A, by recovering the liquid droplets having floated and diffused with a recovery mechanism, a liquid containing fine bubbles 105 is obtained. FIG. 4B is an enlarged view extracting a region IVb in FIG. 4A, and shows fine bubbles 103 thus recovered.

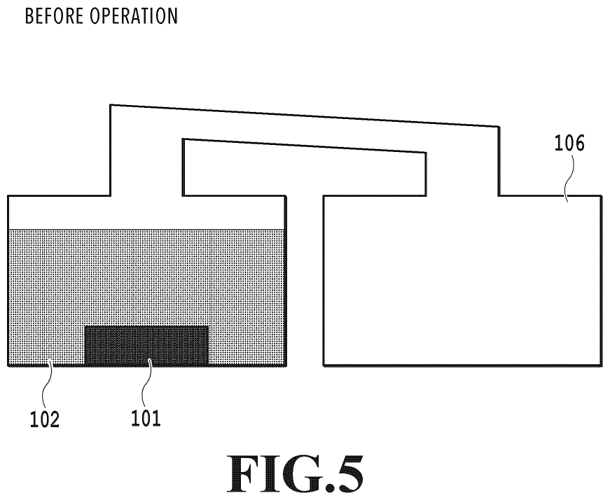

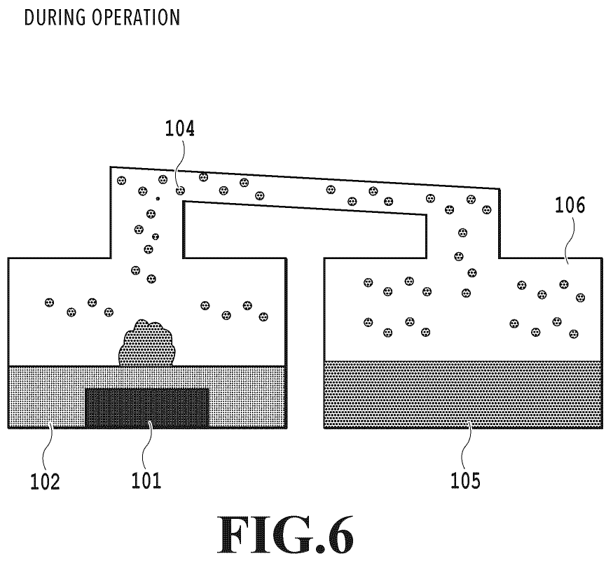

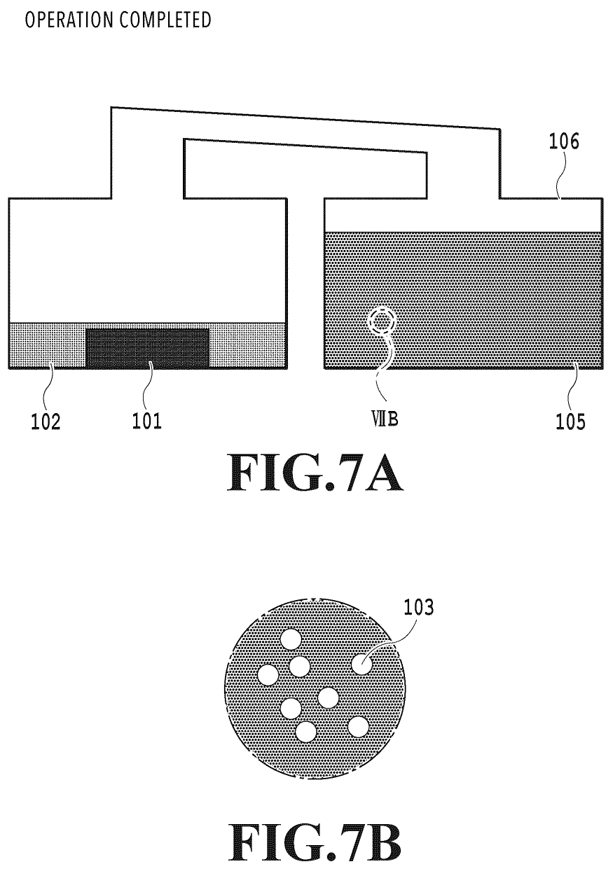

Here, as forms different from the manufacturing device described so far, manufacturing devices having configurations in which a recovery mechanism is provided as a unit different from a manufacturing mechanism will be described by using FIG. 5 to FIG. 9. FIG. 5 shows a state before such a manufacturing device starts operation. By energizing the atomized FB generating device 101 in this state, the ultrasonic vibration is started, and the ultrasonic vibration is applied to a liquid 102. Then, a liquid column is generated to cause atomization as shown in FIG. 6, so that fine bubble-containing liquid droplets 104 float and diffuse. Thereafter, as shown in FIG. 7A, by recovering the liquid droplets having floated and diffused into a recovery container 106, a liquid containing fine bubbles 105 is obtained. FIG. 7B is an enlarged view extracting a region VIIb in FIG. 7A, and shows fine bubbles 103 in the liquid containing fine bubbles 105.

As shown in FIG. 5 to FIG. 7B, by separating the recovery mechanism as a unit different from the vibrator side which generates fine bubbles, a liquid containing fine bubbles can be prevented from returning to the vibrator side. In this way, as described above, fine bubbles can be prevented from being broken with pressure upon receipt of influence of vibrations due to influenced of an ultrasonic wave again.

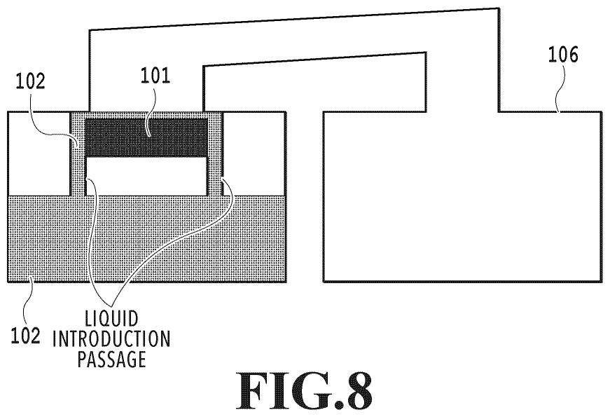

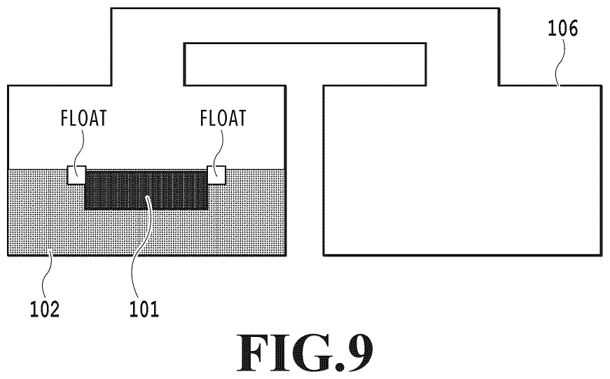

Note that as a unit for atomizing a liquid includes a type in which as shown in FIG. 8, a liquid introduction passage and a liquid film on a surface of a piezoelectric atomization element are provided, and the liquid is supplied to the surface of the piezoelectric atomization element by using capillary action to be atomized besides the immersion type as shown in FIG. 3. In addition, it is possible to use units of various types such as a piezoelectric element of float type which includes floats for floating the piezoelectric element to activate in a liquid surface layer so as to maintain the distance between the surface of the piezoelectric element and the gas-liquid interface as shown in FIG. 9.

In addition, the above description is a basic one based on the configuration of the illustrated manufacturing devices, and it is also possible to improve the productivity of a liquid containing fine bubbles by adding configurations of the manufacturing devices as appropriate.

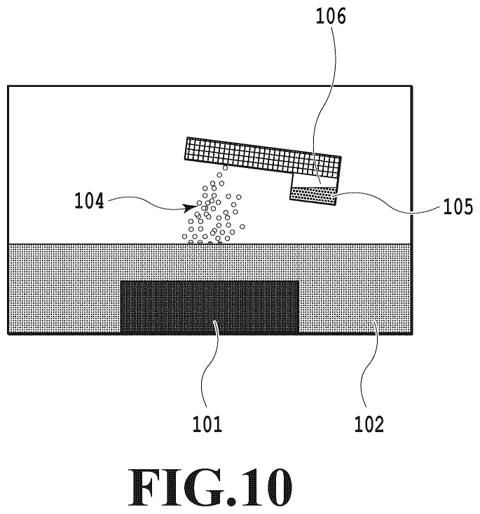

As one example thereof, FIG. 10 shows a configuration in which a liquid containing fine bubbles is recovered by bringing liquid droplets having floated and diffused into contact with an intermedium having a net structure in part. Only the liquid droplets can be recovered through the contact with the net structure.

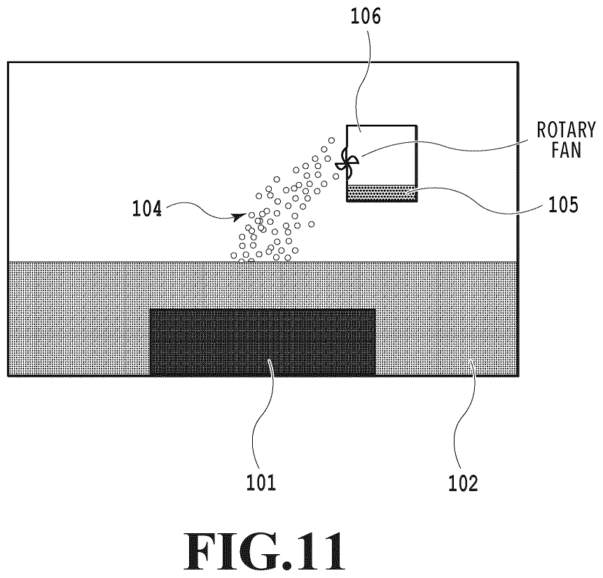

In addition, as another one example, FIG. 11 shows a configuration in which a liquid containing fine bubbles is recovered by using a recovery fan. By using the recovery fan, the liquid containing fine bubbles 105 can be directly recovered into the recovery container 106.

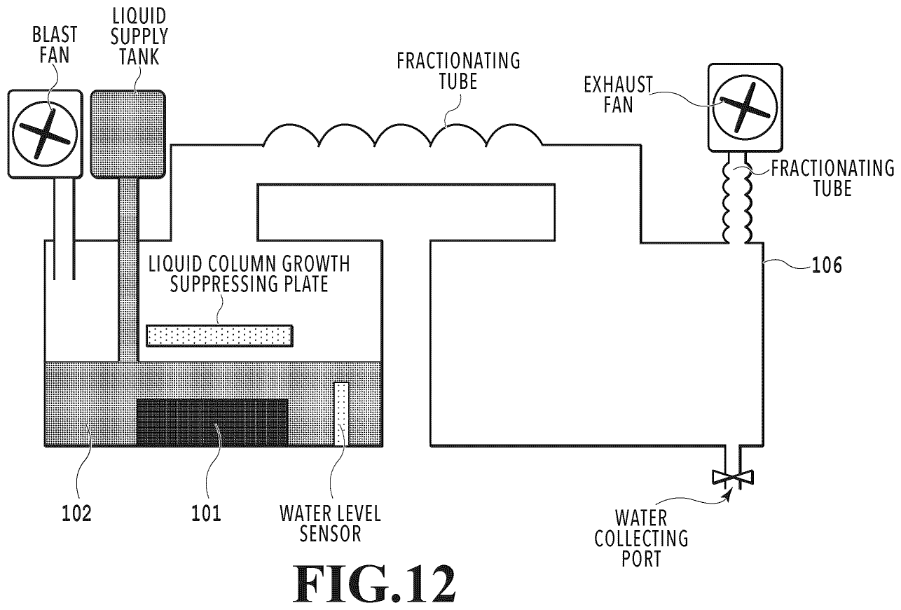

Moreover, as another one example, FIG. 12 shows a configuration provided with a blast fan, a liquid supply tank, a liquid column growth suppressing plate, a water level sensor, fractionating tubes, an exhaust fan, and a water collecting port. By providing the blast fan and the exhaust fan, the efficiency of movement of an atomized aerosol to the recovery mechanism is improved. In addition, by providing the liquid supply tank and the water level sensor, it becomes possible to control the liquid level of the raw material during the operation of the manufacturing device, and boil dry of the piezoelectric atomization unit can be suppressed, and continuous operation for a long period of time becomes possible. In addition, by providing the liquid column growth suppressing plate, it is expected to prevent a bulk liquid other than fine liquid droplets from scattering. In addition, by providing the fractionating tube in a joint pipe, it is expected to make efficient transition from fine liquid droplets in atomized state to a bulk liquid and recovery of the bulk liquid, and further by providing the fractionating tube in a joint portion with the exhaust fan, it is also expected to suppress flowing out of atomized fine liquid droplets to the outside of the manufacturing device. In addition, by providing the water collecting port including a cock, it is possible to collect the liquid containing fine bubbles without opening the manufacturing device.

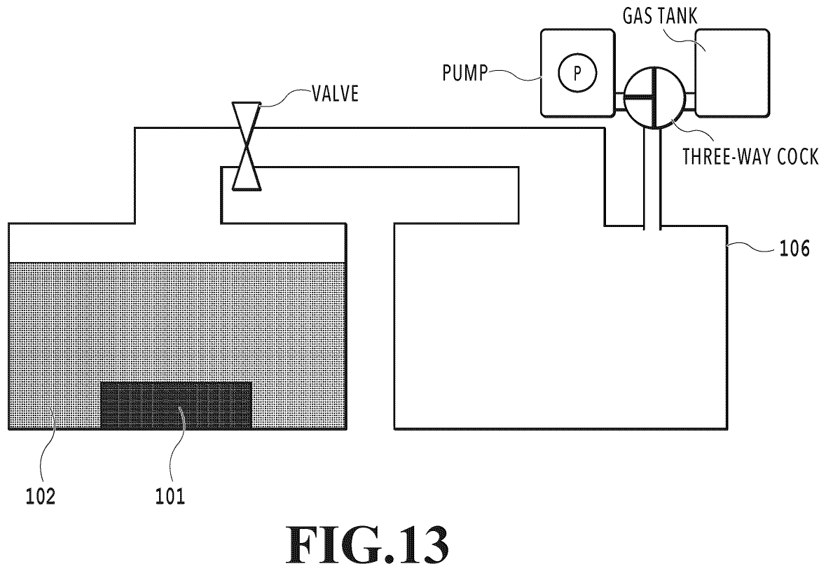

FIG. 13 shows one example in which a pump, a gas tank, a valve, and a three-way cock are provided to control and adjust a gas component in a recovery mechanism including a recovery container 106. The gas component in the recovery container 106 can be controlled to a desired atmosphere by bringing the recovery container into a reduced pressure with the pump, and conducting purge of the gas component in the gas tank filled with a desired gas type in a desired proportion, in the state where the valve is closed. Thereafter, a liquid containing fine bubbles containing the desired gas component can be manufactured by opening the valve, atomizing the liquid 102 through irradiation with an ultrasonic wave, and recovering the bulk liquid. Alternatively, as shown in FIG. 12, by providing a unit having the same configuration and an agitating unit on the atomized FB generating device 101 side as well, it is also possible to conduct such a control that a desired gas component is obtained from the stage of a dissolved gas component in a raw material liquid.

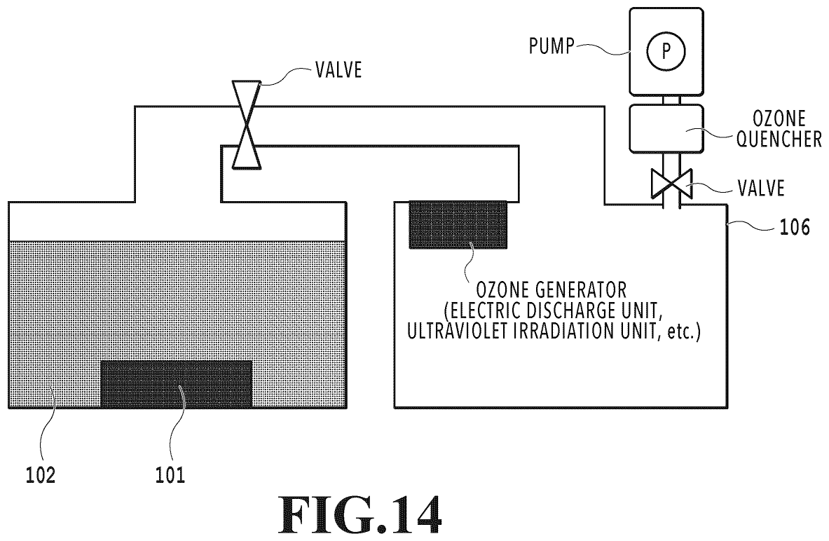

FIG. 14 shows one example of a manufacturing device for a liquid containing fine bubbles containing ozone. A liquid containing fine bubbles containing ozone can be manufactured by adjusting the atmosphere in a recovery mechanism to a desired ozone gas concentration by using an ozone generator provided in a recovery container 106 in the recovery mechanism, thereafter, atomizing a liquid 102, and recovering a bulk liquid.

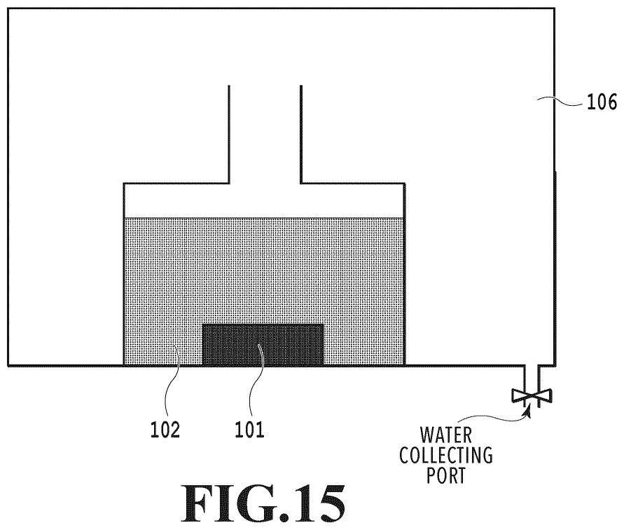

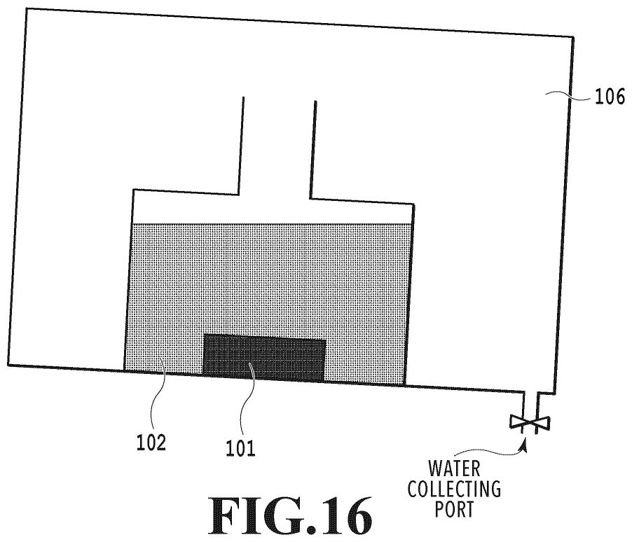

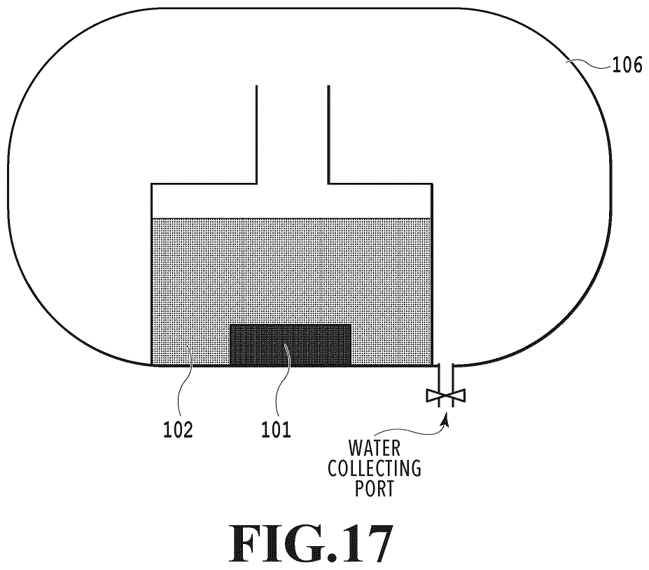

FIG. 15 shows an example in which a liquid tank is provided inside a recovery container 106. A liquid is reserved in the liquid tank, and an atomized FB generating device 101 is attached inside the liquid tank, and the entire liquid tank is covered with the recovery container 106. FIG. 16 shows a usage example in which the recovery efficiency is improved by tilting the recovery mechanism shown in FIG. 15. FIG. 17 shows one example in the case where a material having flexibility is used for a wall of a recovery container 106. By providing flexibility, an internal airflow can be generated by deforming the recovery container 106 with a force from outside, so that it is expected to effectively recover atomized liquid droplets from inside the liquid tank.

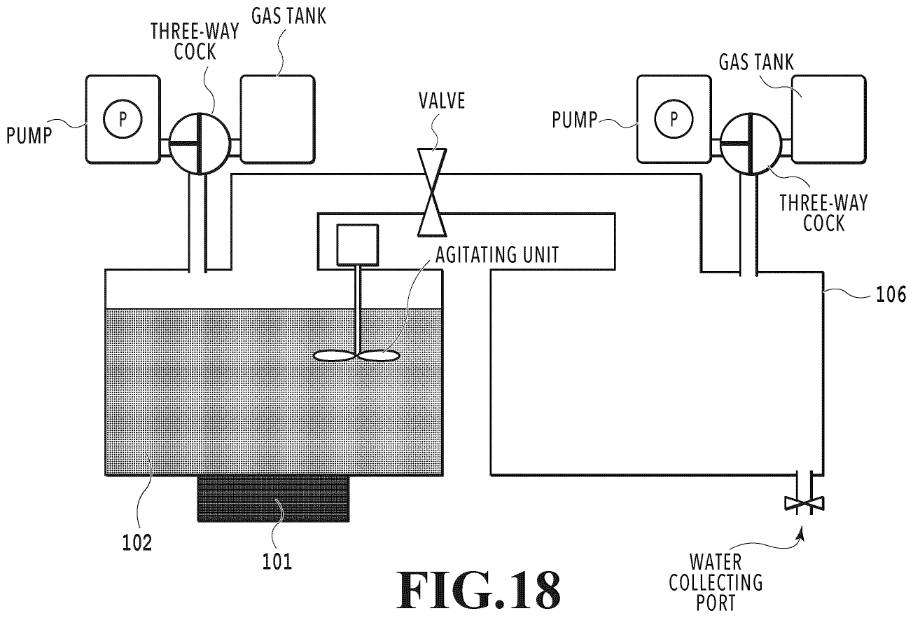

FIG. 18 is a diagram showing one example of a manufacturing device for a liquid containing fine bubbles which is capable of adjusting a dissolved gas component as well as a gas component and a partial pressure in a recovery container.

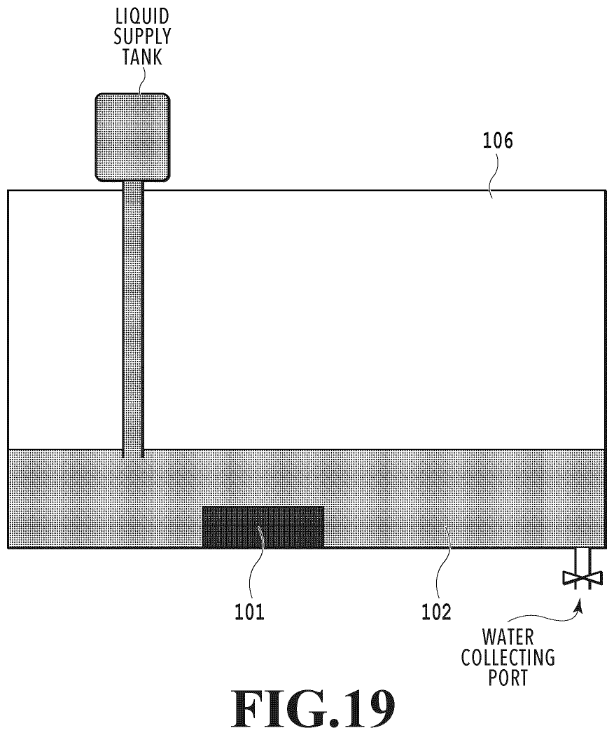

FIG. 19 shows one example of a manufacturing device in which a liquid tank to which a raw material liquid is supplied and a recovery mechanism for fine bubbles are integrated. As shown in the diagram, the manufacturing device is covered with a recovery container 106. By integrating the liquid tank to be supplied with the raw material liquid and the recovery mechanism, reduction in size and reduction in weight of the manufacturing device are expected.

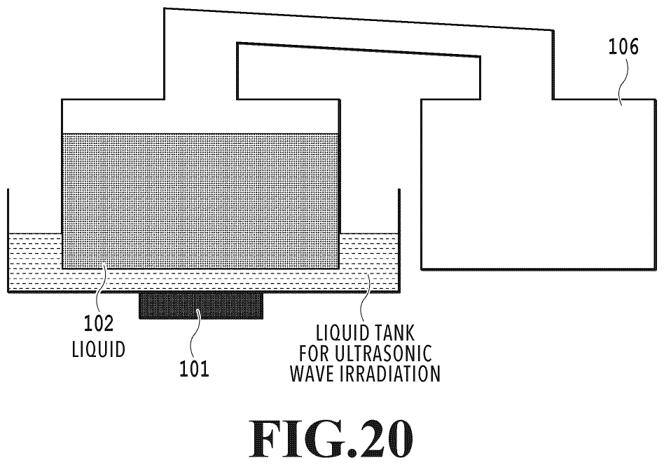

FIG. 20 is a diagram showing one example of a manufacturing device which separates liquids. Specifically, the manufacturing device separates a first liquid which is used as a raw material of a liquid containing fine bubbles and a second liquid which is to be irradiated with an ultrasonic wave. By irradiating the second liquid with the ultrasonic wave, indirect piezoelectric atomization is conducted on the first liquid. This configuration is favorable in the case of generating fine bubbles in such a liquid that corrodes an ultrasonic wave generating unit.

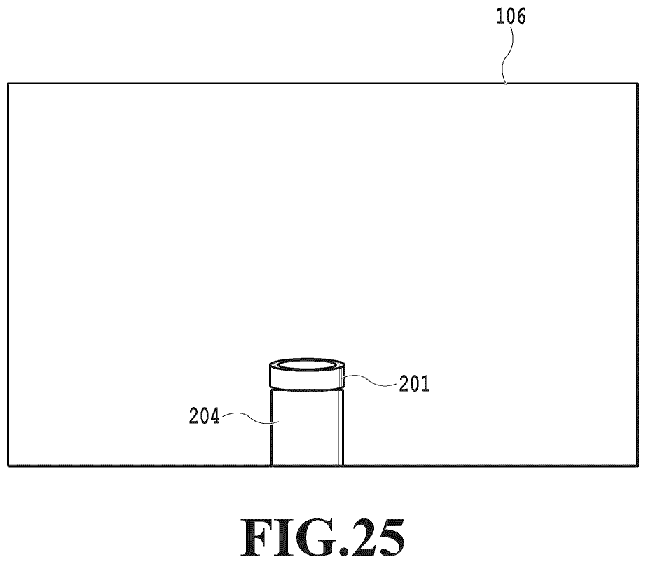

Here, a flow of manufacturing a liquid containing fine bubbles by using the manufacturing device shown in FIG. 24A and FIG. 24 B will be described by using FIG. 25.

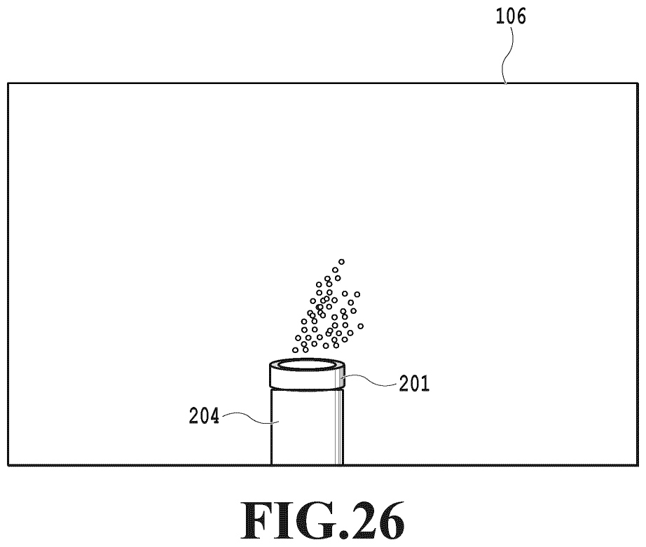

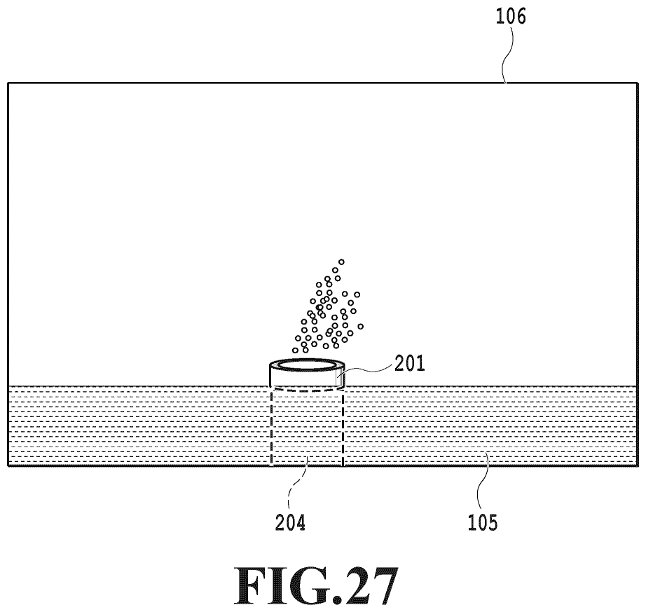

FIG. 25 shows a state before the manufacturing device starts operation. As shown in FIG. 25, a reservoir chamber 204 in which water is reserved is installed on a bottom surface of a recovery container 106 of the manufacturing device. On this reservoir chamber 204, an atomized FB generating device 201 is installed. Inside the reservoir chamber 204, a sponge is placed at a position corresponding to an upper portion of the reserved water, and the water inside reservoir chamber 204 is supplied to the atomized FB generating device 201 through this sponge with capillary force or the like to reach a mesh 202. By energizing the atomized FB generating device 201 in the state shown in FIG. 25, ultrasonic vibration is started. Applying ultrasonic vibrations causes liquid droplets of a liquid containing fine bubbles to float and diffuse as shown in FIG. 26. Thereafter, as shown in FIG. 27, by recovering the liquid droplets having floated and diffused with a recovery mechanism, a liquid containing fine bubbles 105 is obtained, as in the case of FIG. 4A. The reservoir chamber 204 and the space in which the liquid droplets of the liquid containing fine bubbles are accumulated are covered with wall surfaces of the recovery container 106.

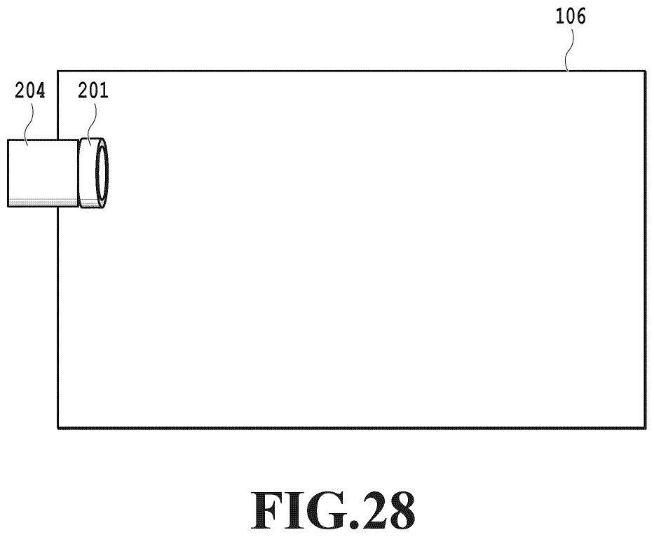

Note that the manufacturing device using the atomized FB generating device 201 is not limited to the form shown in FIG. 25. Here, forms different from the above-mentioned one will be described by using FIGS. 28 to 30. In FIGS. 28 to 30, the atomized FB generating device 201 is installed in directions changed from the form of FIG. 25, so that the direction of a generated mist is made different.

FIG. 28 shows a state before a manufacturing device different from FIG. 25 starts operation. By energizing the atomized FB generating device 201 in this state, the ultrasonic vibration is started. Then, the ultrasonic vibration is applied to the liquid, so that liquid droplets of the liquid containing fine bubbles float and diffuse. As shown in FIG. 28, since the atomized FB generating device 201 is laterally installed, the liquid droplets of the liquid containing fine bubbles drop with their own weights, and the liquid having dropped can be recovered with the recovery container 106.

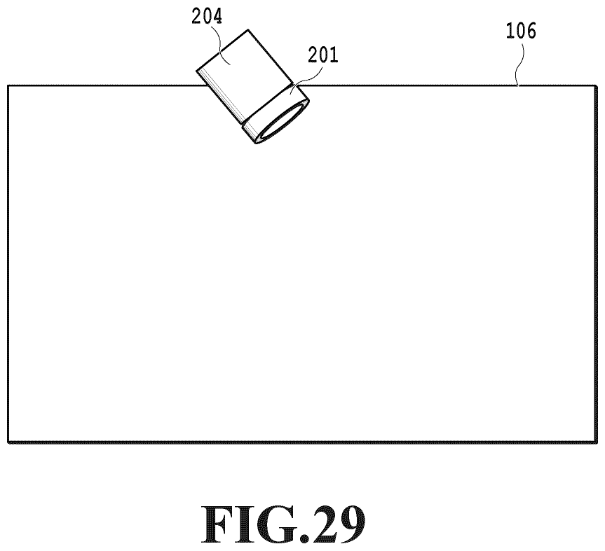

FIG. 29 shows a state before a manufacturing device starts operation as in FIG. 28, but shows a form in which the atomized FB generating device 201 is installed obliquely downward as compared with FIG. 28. By energizing the atomized FB generating device 201 in this state, the ultrasonic vibration is started, and in the case where the ultrasonic vibration is applied to the liquid, liquid droplets of the liquid containing fine bubbles float and diffuse. Thereafter, the liquid droplets of the liquid containing fine bubbles drop with their own weights and are accumulated in the recovery container 106. The user can recover the liquid containing fine bubbles accumulated in the recovery container 106.

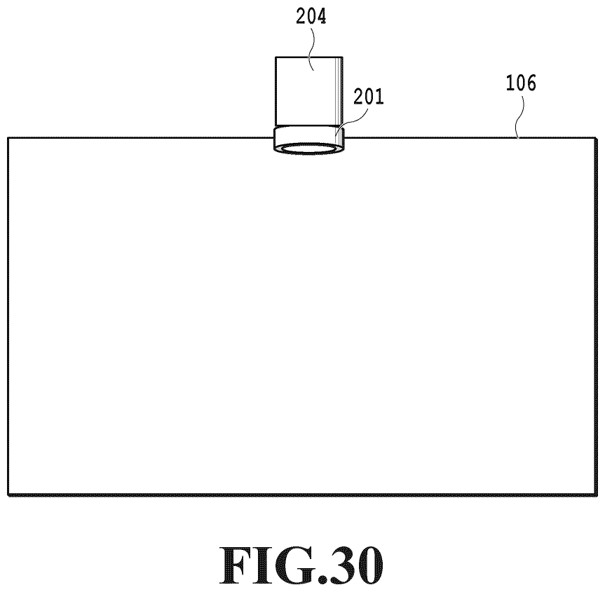

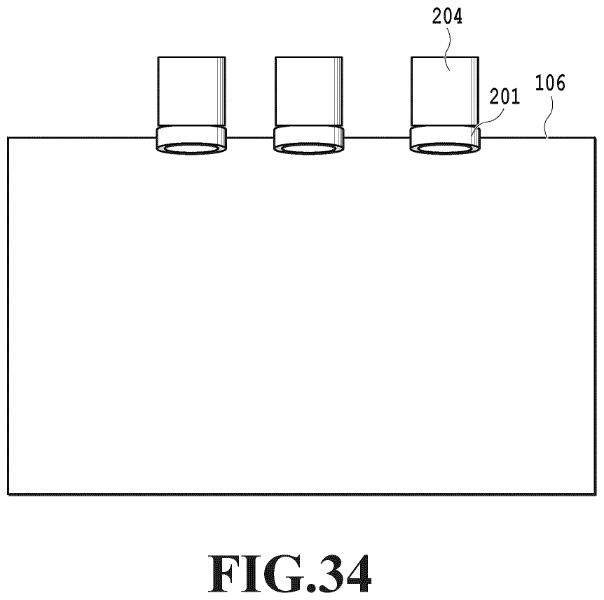

FIG. 30 shows a state before the manufacturing device starts operation as in FIG. 28 and FIG. 29, but shows a form in which the atomized FB generating device 201 is installed downward as compared with FIG. 28 and FIG. 29. By energizing the atomized FB generating device 201 in this state, the ultrasonic vibration is started, and in the case where the ultrasonic vibration is applied to the liquid, liquid droplets of the liquid containing fine bubbles float and diffuse. Thereafter, the liquid droplets of the liquid containing fine bubbles drop with their own weights, and are accumulated in the recovery container 106. The user can recover the liquid containing fine bubbles accumulated in the recovery container 106. Note that in the form of FIG. 29 or FIG. 30, since water in the reservoir chamber 204 moves downward with its own weight, it is thus possible to cause water to reach the mesh 202 even without inserting a sponge in the reservoir chamber 204. Note that although in the present example, the forms in which one atomized FB generating device 201 is provided are shown, the manufacturing device may include a plurality of atomized FB generating devices 201. For example, as shown in FIG. 34, the manufacturing device may include three atomized FB generating devices 201.

In the form of FIG. 25, liquid droplets of a liquid containing fine bubbles attach to the surface of the mesh 202 in some cases, and there is a case where a failure in discharge of the liquid occurs due to this. In view of this, in each form of FIG. 28 to FIG. 30, since the probability that liquid droplets of a liquid containing fine bubbles attach to the surface of the mesh 202 decreases, a reduction in productivity due to a failure in discharge can be prevented. In addition, in the case where a gas contained in a manufactured liquid containing fine bubbles is an active oxygen such as ozone, in each form of FIG. 28 to FIG. 30, since the atomized FB generating device 201 can be installed in an upper portion of the recovery container 106, degradation of the atomized FB generating device 201 can be suppressed.

Hereinafter, humidity in the recovery mechanism (the recovery container 106 and the like) will be described. The humidity described herein is a relative humidity, and an atmosphere in which a gas component a relative humidity of which is to be obtained does not exist at all in a recovery mechanism is regarded as 0%, and an atmosphere in which the gas component condenses in a recovery mechanism is regarded as 100%. In the case where the target liquid is water, the humidity can be observed by using a general-purpose hygrometer. However, in the case where the target liquid is not water, it is necessary to confirm that the component of the liquid does not exist in a recovery container at the time of starting manufacture of fine bubbles. In this confirmation, an approach of confirmation using a gas detecting tube for the component of the target liquid or the like is useful. After the confirmation, the manufacture of a liquid containing fine bubbles is started, and a state where condensation has occurred in the recovery mechanism is regarded as the state in which the relative humidity of the target liquid is 100%. Hence, after this state, in a period of time when fine bubbles are generated by atomization by energization, the state in which the relative humidity is 100% continues. Then, an “average value of relative humidity” used herein indicates an average value of relative humidity in the space of the recovery mechanism from the start of manufacture of a liquid containing fine bubbles to the end of manufacture.

### (Description of Specific Examples)

Hereinafter, results of manufacturing a liquid containing fine bubbles with various conditions at the time of manufacture by using fine bubble manufacturing devices such as the device shown in FIG. 2, and checking the liquid containing fine bubbles thus manufactured will be described.

For the measurement of fine bubbles in the liquid containing fine bubbles manufactured, a measuring instrument (model number SALD-7500) manufactured by Shimadzu Corporation was used. As a comparison target, a raw material liquid before fine bubbles were generated was used. The average particle diameter (in terms of the number of particles), the concentration (the accumulated number of bubbles having a particle diameter of 20 μm or less per ml), and the particle diameter distribution (the ratio (dw/dn) of the average molecular weight (dn) in terms of the number of particles to the average particle diameter (dw) in terms of volume, the minimum value was 1) of the fine bubbles contained in the liquid containing fine bubbles were measured.

For the quantification of in-liquid components to be analyzed, PACK TEST manufactured by KYORITSU CHEMICAL-CHECK Lab., Corp. was used. For the analysis of viable bacterium contamination, Biochecker manufactured by SAN-AI OIL CO., LTD. was used. For the measurement of the amount of dissolved oxygen, DO Meter (HQ30D) manufactured by HACH was used. For the pH measurement, LAQUA pH meter manufactured by HORIBA was used. In addition, in the experiments under the atmosphere, the gas atmosphere was set to 21% of oxygen and 79% of nitrogen, and the concentration of the dissolved gas component was calculated based on a result of measurement of the oxygen concentration.

The evaluation items and evaluation criteria are as described below.

As the index for the storage stability of the FB-containing liquid, the change rate of the UFB concentration after one week at room temperature was obtained and evaluated.

The determination criteria are described below.
A . . . 80% or more
B . . . 50% or more and less than 80%
C . . . 10% or more and less than 50%
D . . . less than 10%

As the index for the production efficiency of the FB-containing liquid, a ratio of the weight of the recovered liquid to the weight of the raw material liquid was obtained and evaluated. The evaluation criteria are described below.
A . . . 95% or more
B . . . 80% or more and less than 95%
C . . . 10% or more and less than 80%
D . . . less than 10%

As the index for the stable productivity of the FB-containing liquid, a ratio of decrease in consumed amount of the raw material liquid per unit time, that is, a ratio of decreased in consumed amount with time to the initial state was obtained and evaluated.

The evaluation criteria are described below.
A . . . 100%
B . . . 50% or more and less than 100%
C . . . 10% or more and less than 50%
D . . . less than 10%

In addition, the sterilization effect of the FB-containing liquid was checked. Specifically, a comparison test with ultra-pure water in the case where a test liquid of the FB-containing liquid was added to a suspension containing E. coli and Staphylococcus aureus was conducted by using Biochecker. The evaluation criteria are described below.
A . . . 99% or more
B . . . 80% or more and less than 99%
C . . . 50% or more and less than 80%
D . . . less than 50%

Moreover, the ozone concentration was checked. The concentrations of dissolved ozone in the initial state before the manufacture of the FB-containing liquid and after the storage of the FB-containing liquid were determined based on a color reaction with a Trinder reagent through oxidative coupling. Note that in the case where the concentration reached the concentration upper limit on the measurement, the liquid was diluted with ultra-pure water, and the concentration was obtained through concentration conversion. The test liquid was sealed in a PFA container without a gas phase, and stored for one week at room temperature. The evaluation criteria regarding the ozone concentration after the time elapsed are described below.
A . . . 2 ppm or more
B . . . 1 ppm or more and less than 2 ppm
C . . . 0.1 ppm or more and less than 1 ppm
D . . . less than 0.1 ppm

### Example 1

As a piezoelectric element as the atomized FB generating device 101 for generating an ultrasonic wave, a piezoelectric atomization element (1.6 MHz) manufactured by SEIKO GIKEN INC. was used. The piezoelectric element was set in a 500-ml beaker, and 300 ml of ultra-pure water was poured. The height at which the piezoelectric element was set was adjusted such that the distance between the gas-liquid interface and the surface of the piezoelectric element became 3.5 cm. A liquid containing fine bubbles was manufactured by using the manufacturing device shown in FIG. 2. The average value of the relative humidity in the recovery container at the time of the manufacture (referred to as an average relative humidity) was 99%. Note that in the case where there is no description in particular in the following Examples, it means that the average relative humidity was 80% or more. In addition, the weight ratio of the liquid containing fine bubbles as a recovered liquid to the consumed amount of the raw material liquid associated with the manufacture was 99%. Note that in the case where there is no description in particular in the following Examples, it means that the weight ratio of the liquid containing fine bubbles to the raw material liquid was 80% or more.

### Example 2

Like Example 1, as the piezoelectric element for generating an ultrasonic wave, the piezoelectric atomization element (1.6 MHz) manufactured by SEIKO GIKEN INC. was used. The piezoelectric element was set in a 500-ml beaker, and 300 ml of ultra-pure water was poured. The height at which the piezoelectric element was set was adjusted such that the distance between the gas-liquid interface and the surface of the piezoelectric element became 3.5 cm. In the recovery of a liquid containing fine bubbles, the liquid containing fine bubbles was manufactured by using a manufacturing device including the recovery container 106 having a net structure of 1 mm shown in FIG. 10. The average relative humidity in the recovery container at the time of the manufacture was 99%. The weight ratio of the liquid containing fine bubbles as a recovered liquid to the consumed amount of the raw material liquid associated with the manufacture was 99%. Note that the pore diameter of the net in the net structure is preferably any one value within a range of 1 mm or more and 3 mm or less.

### Example 3

Like Example 1, as the piezoelectric element for generating an ultrasonic wave, the piezoelectric atomization element (1.6 MHz) manufactured by SEIKO GIKEN INC. was used. The piezoelectric element was set in a 500-ml beaker, and 300 ml of ultra-pure water was poured. The height at which the piezoelectric element was set was adjusted such that the distance between the gas-liquid interface and the surface of the piezoelectric element became 3.5 cm. In the recovery of a liquid containing fine bubbles, the liquid containing fine bubbles was manufactured by using a manufacturing device including a recovery container to which a rotary vane (fan) as shown in FIG. 11 was attached and which sucks and recovers a mist using the fan. The average relative humidity in the recovery container at the time of the manufacture was 99%. In addition, the weight ratio of the liquid containing fine bubbles as a recovered liquid to the consumed amount of the raw material liquid associated with the manufacture was 99%.

### Example 4

The manufacturing device shown in FIG. 5 was used. As the piezoelectric element (atomized FB generating device 101) for generating an ultrasonic wave, the piezoelectric atomization element (1.6 MHz) manufactured by SEIKO GIKEN INC. was used. The piezoelectric element was set in a 500-ml separable two-necked flask, and 300 ml of ultra-pure water was poured. The height at which the piezoelectric element was set was adjusted such that the distance between the gas-liquid interface and the surface of the piezoelectric element became 3.5 cm. A power supply cord was inserted through one neck of the two-necked flask, a joint pipe was provided in the other neck, and the recovery container 106 was provided on the front end of the joint pipe. A recovery mechanism including the recovery container 106 was configured as a closed system such that the ambient atmosphere did not flow therein. Note that the “closed system” means a system in which the exchange of a substance with the outside is restricted. A liquid containing fine bubbles was manufactured by using such a manufacturing device. The average relative humidity in the recovery container at the time of the manufacture was 99%. In addition, the weight ratio of the liquid containing fine bubbles as a recovered liquid to the consumed amount of the raw material liquid associated with the manufacture was 99%.

### Example 5

The height at which the piezoelectric element was set was adjusted such that the distance between the gas-liquid interface and the surface of the piezoelectric element became 15 cm in Example 4. In addition, for the introduction of ozone into a gas component in the recovery mechanism of the closed system, an ozone generator was provided in the recovery mechanism, and a water collecting port, valves, an ozone quencher, and a pump were provided, as shown in FIG. 14.

The ozone generator used is not particularly limited, and any unit can be used. Specifically, although a manufacturing unit using ultraviolet ray irradiation (a low pressure mercury lamp or a Xe excimer lamp having quartz pipe glass, or the like), an electric discharge unit, or the like can be used, ozonization with creeping discharge was employed in the present Example. Although the ozone quencher is not particularly limited as long as the ozone quencher adsorbs or decomposes ozone to oxygen (for example, a manganese oxide or a 254-nm ultraviolet lamp), activated carbon was used in the present Example.

A liquid containing fine bubbles containing ozone was manufactured in the same manner as in Example 4 except for the above-described change.

### Example 6

A liquid containing fine bubbles was manufactured in the same manner as in Example 4 except that the height at which the piezoelectric element was set was adjusted such that the distance between the gas-liquid interface and the surface of the piezoelectric element became 16 cm in Example 4.

### Example 7

A liquid containing fine bubbles was manufactured in the same manner as in Example 4 except that a manufacturing device covered with a recovery container was used as shown in FIG. 19 in Example 4.

### Example 8

A liquid containing fine bubbles was manufactured in the same manner as in Example 4 except that ultra-pure water was changed to a 58-vol % ethanol aqueous solution in Example 4. Note that in the recovery mechanism before the manufacture of the liquid containing fine bubbles, it was confirmed that the gas concentration of the ethanol component was 0% by using an alcohol detecting tube, and also it was configured that the relative humidity of water was 40%. Based on this result, the relative humidity in the recovery mechanism before the manufacture for the 58-vol % ethanol aqueous solution was calculated to be 23.2%. In addition, at the time of completion of the manufacture, the liquid component ratio of the manufactured and recovered liquid containing fine bubbles was similar to the raw material before the manufacture. From this fact, it was confirmed that for the target liquid (the 58-vol % ethanol aqueous solution in the present case), in the case where the state at the time of generation of condensation during the manufacture was regarded as 100%, the average relative humidity was 99%.

### Example 9

A liquid containing fine bubbles was manufactured in the same manner as in Example 4 except that the distance between the gas-liquid interface and the surface of the piezoelectric element was changed to 10 cm in Example 4.

### Example 10

A liquid containing fine bubbles was manufactured in the same manner as in Example 4 except that the distance between the gas-liquid interface and the surface of the piezoelectric element was changed to 11 cm in Example 4.

### Example 11

A liquid containing fine bubbles was manufactured in the same manner as in Example 4 except that the average relative humidity in the recovery container at the time of the manufacture was changed to 88% in Example 4.

### Example 12

A liquid containing fine bubbles was manufactured in the same manner as in Example 4 except that ultra-pure water was changed to tap water in Example 4.

### Example 13

A liquid containing fine bubbles was manufactured in the same manner as in Example 4 except that ultra-pure water was changed to hard water in Example 4.

### Example 14

A liquid containing fine bubbles was manufactured in the same manner as in Example 4 except that ultra-pure water was changed to rainwater in Example 4.

### Example 15

A liquid containing fine bubbles was manufactured in the same manner as in Example 4 except that ultra-pure water was changed to seawater in Example 4.

### Example 16

A liquid containing fine bubbles was manufactured in the same manner as in Example 4 except that a blast fan, a liquid supply tank, a liquid column growth suppressing plate, a water level sensor, fractionating tubes, an exhaust fan, and a water collecting port were provided as shown in FIG. 12 in Example 4.

Note that the average relative humidity in the recovery container at the time of the manufacture was 80%, and the weight ratio of the liquid containing fine bubbles to the raw material liquid was 80%.

### Example 17

A liquid containing fine bubbles was manufactured in the same manner as in Example 4 except that a flexibility was given to the wall of the recovery container and a water collecting port was provided in the recovery container as shown in FIG. 17 in Example 4. By giving flexibility, the shape of the recovery container was changed as appropriate to generate a gas flow in the recovery container. This made it possible to shorten the time required for recovering a predetermined amount through atomization by 5%.

### Example 18

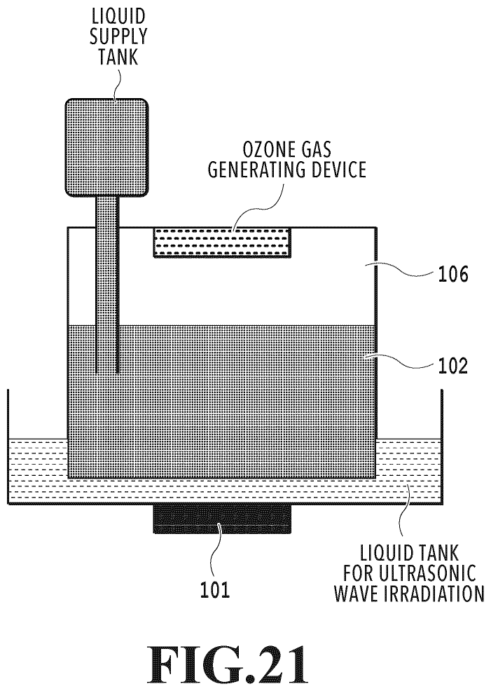

A recovery mechanism was configured such that an ozone generator was provided in the recovery mechanism, a first liquid was directly irradiated, and a second liquid (raw material liquid) phase was indirectly irradiated, with a 1.6-MHz ultrasonic wave by using a piezoelectric element (manufactured by KAIJO corporation), and further the recovery mechanism included a liquid supply tank as shown in FIG. 21 in Example 1. A liquid containing fine bubbles was manufactured in the same manner as in Example 4 except for these.

The ozone generator is not particularly limited, and any unit can be used. Specifically, although a manufacturing unit using ultraviolet ray irradiation (a low pressure mercury lamp or a Xe excimer lamp having quartz pipe glass, or the like), an electric discharge unit, or the like can be used, a low pressure mercury lamp (output 5 W) having a wavelength of 172 nm was used in the present Example.

### Example 19

Manufacture was conducted in which the gas component in the manufacturing device of the closed system was replaced with argon in Example 4. The manufacturing device shown in FIG. 13 was used for the replacement with argon, in which in the state where the valve in the recovery container was open, degassing with reduced pressure was conducted by using the pump, and thereafter, the gas component of the manufacturing device of the closed system was replaced with argon from the gas tank filled with argon by rotating the three-way cock. Although this operation may be conducted once, the replacement can be more effectively achieved by conducting this operation several times, and it is also effective to provide an independent closed space on the raw material liquid side and to conduct the aforementioned replacement operation while agitating the raw material liquid, as shown in FIG. 18. A liquid containing fine bubbles was manufactured in the same manner as in Example 4 except for the above-described change.

### Example 20

Manufacture was conducted in which the gas component in the manufacturing device of the closed system was replaced with pure air in Example 4. The manufacturing device shown in FIG. 13 was used for the replacement with pure air, in which in the state where the valve in the recovery container was open, degassing with reduced pressure was conducted by using the pump, and thereafter, the gas component of the manufacturing device of the closed system was replaced with pure air from the gas tank filled with pure air by rotating the three-way cock. Note that pure air indicates a gas from which carbon dioxide, nitrogen oxide, THC, sulfur dioxide, and the like were removed as much as possible such that the gas is composed mainly of two components of oxygen and nitrogen.

A liquid containing fine bubbles was manufactured in the same manner as in Example 4 except for the above-described change.

### Example 21

Manufacture was conducted in which the gas component in the manufacturing device of the closed system was replaced with oxygen in Example 4. The manufacturing device shown in FIG. 13 was used for the replacement with oxygen, in which in the state where the valve in the recovery container was open, degassing with reduced pressure was conducted by using the pump, and thereafter the gas component of the manufacturing device of the closed system was replaced with oxygen from the gas tank filled with oxygen by rotating the three-way cock.

A liquid containing fine bubbles was manufactured in the same manner as in Example 4 except for the above-described change.

### Example 22

Manufacture was conducted in which the gas component in the manufacturing device of the closed system was replaced with nitrogen in Example 4. The manufacturing device shown in FIG. 13 was used for the replacement with nitrogen, in which in the state where the valve in the recovery container was open, degassing with reduced pressure was conducted by using the pump, and thereafter the gas component of the manufacturing device of the closed system was replaced with nitrogen from the gas tank filled with nitrogen by rotating the three-way cock.

A liquid containing fine bubbles was manufactured in the same manner as in Example 4 except for the above-described change.

### Example 23

Manufacture was conducted in which the gas component in the manufacturing device of the closed system was replaced with CO2 in Example 4. The manufacturing device shown in FIG. 13 was used for the replacement with CO2, in which in the state where the valve in the recovery container was open, degassing with reduced pressure was conducted by using the pump, and thereafter the gas component of the manufacturing device of the closed system was replaced with CO2 from the gas tank filled with CO2 by rotating the three-way cock. Note that the concentration of CO2 was derived by using a correlation curve between the CO2 gas concentration in a CO2-dissolved water and the pH of the CO2-dissolved water and a carbon dioxide gas concentration meter by a membrane-type glass electrode method.

A liquid containing fine bubbles was manufactured in the same manner as in Example 4 except for the above-described change.

### Example 24

Manufacture was conducted in which the gas component in the manufacturing device of the closed system was replaced with hydrogen in Example 4. The manufacturing device shown in FIG. 13 was used for the replacement with hydrogen, in which in the state where the valve in the recovery container was open, degassing with reduced pressure was conducted by using the pump, and thereafter the gas component of the manufacturing device of the closed system was replaced with hydrogen from the gas tank filled with hydrogen by rotating the three-way cock.

A liquid containing fine bubbles was manufactured in the same manner as in Example 4 except for the above-described change.

### Example 25

An ultraviolet lamp having a wavelength of 254 nm was provided instead of the ozone generator shown in FIG. 14, and a water collecting port and a valve were provided in the recovery container, in Example 4. A liquid containing fine bubbles was manufactured in the same manner as in Example 4 except for these. Note that the ultraviolet lamp used is not particularly limited. The ultraviolet ray irradiation using the ultraviolet lamp was conducted for the purpose of eradication of bacteria in the installation environment of the manufacturing device.

A liquid containing fine bubbles was manufactured in the same manner as in Example 4 except for the above-described change.

### Example 26

An ultraviolet lamp having a wavelength of 185 nm was provided instead of the ozone generator shown in FIG. 14, and a water collecting port and a valve were provided, in Example 4. A liquid containing fine bubbles was manufactured in the same manner as in Example 4 except for these.

A liquid containing fine bubbles was manufactured in the same manner as in Example 4 except for the above-described change.

### Example 27

An ultraviolet lamp having a wavelength of 172 nm was provided instead of the ozone generator shown in FIG. 14, and a water collecting port and a valve were provided, in Example 4. A liquid containing fine bubbles was manufactured in the same manner as in Example 4 except for these.

### Example 28

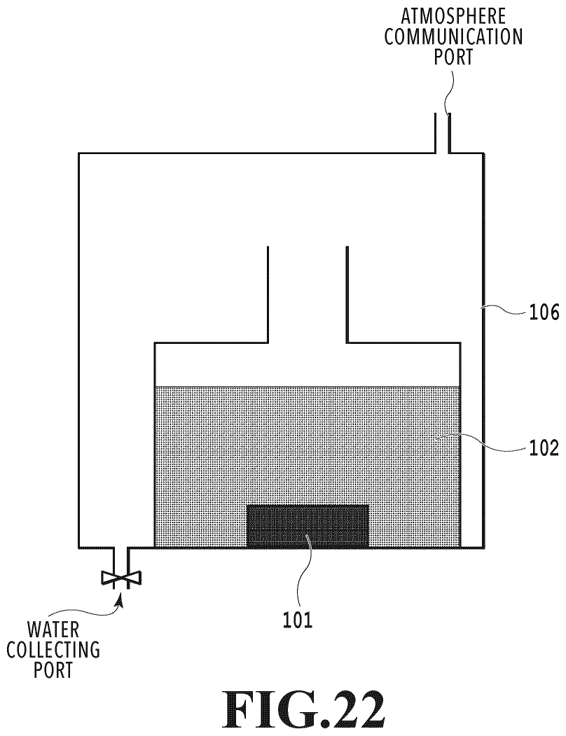

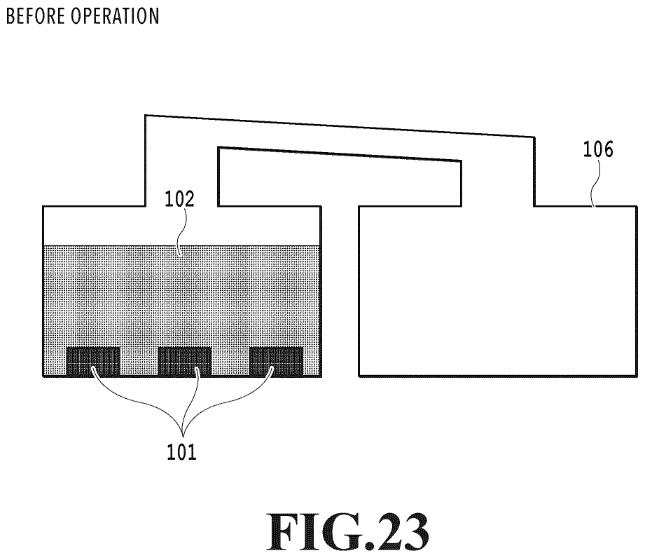

An atmosphere communication port and a water collecting port shown in FIG. 22 were provided in Example 4, and a liquid containing fine bubbles was manufactured by using a fine bubble-containing liquid manufacturing device covered with the recovery container 106.

A liquid containing fine bubbles was manufactured in the same manner as in Example 4 except for the above-described change.

### Example 29

A liquid introduction passage was provided, and a vibrator, that is, an atomized FB generating device 101 was provided directly below a liquid film as shown in FIG. 8, in Example 4. A liquid containing fine bubbles was manufactured in the same manner as in Example 4 except for these.

### Example 30

An atomized FB generating device 101 was provided in such a manner as to float in a liquid as shown in FIG. 9, in Example 4. A liquid containing fine bubbles was manufactured in the same manner as in Example 4 except for this.

### Example 31

A liquid containing fine bubbles was manufactured by using a manufacturing device having a structure shown in FIG. 25, which was equipped with a self-made atomized FB generating device 201. Regarding the atomized FB generating device 201, as a so-called mesh-type atomization generator, a transducer that is used in an ultrasonic humidifier was utilized. It is known that liquid droplets of about 10 μm are generated by utilizing this. As the liquid, ultra-pure water was used. The average value of the relative humidity in the recovery container at the time of manufacturing the liquid containing fine bubbles (referred to as an average relative humidity) was 99%. Note that in the case where there is no description in particular in the following Examples, it means that the average relative humidity was 80% or more. In addition, the weight ratio of the liquid containing fine bubbles as a recovered liquid to the consumed amount of the raw material liquid associated with the manufacture was 99%. Note that in the case where there is no description in particular in the following Examples, it means that the weight ratio of the liquid containing fine bubbles to the raw material liquid was 80% or more.

### Example 32

A liquid containing fine bubbles was manufactured by using a manufacturing device having the structure shown in FIG. 28, which was equipped with the atomized FB generating device 201. The other conditions are the same as in Example 31. By laterally installing the atomized FB generating device 201, the time required for recovering a predetermined amount of the liquid containing fine bubbles was able to be shortened by 10% as compared with Example 31.

### Example 33

A liquid containing fine bubbles was manufactured by using a manufacturing device having the structure shown in FIG. 29, which was equipped with the atomized FB generating device 201. The other conditions were the same as in Example 31. By installing the atomized FB generating device 201 obliquely, the time required for recovering a predetermined amount of the liquid containing fine bubbles was able to be shortened by 20% as compared with Example 31.

### Example 34

A liquid containing fine bubbles was manufactured by using a manufacturing device having the structure shown in FIG. 30, which was equipped with the atomized FB generating device 201. The other conditions were the same as in Examples 31 to 33. By installing the atomized FB generating device 201 downward, the time required for recovering a predetermined amount of the liquid containing fine bubbles was able to be shortened by 30% as compared with Example 31.

### Example 35

A liquid containing fine bubbles was manufactured in the same manner as in Example 34 except that ultra-pure water was changed to tap water in Example 34.

### Example 36

A liquid containing fine bubbles was manufactured in the same manner as in Example 34 except that ultra-pure water was changed to hard water in Example 34.

### Example 37

A liquid containing fine bubbles was manufactured in the same manner as in Example 34 except that ultra-pure water was changed to rainwater in Example 34.

### Example 38

A liquid containing fine bubbles was manufactured in the same manner as in Example 34 except that ultra-pure water was changed to seawater in Example 34.

### Example 39

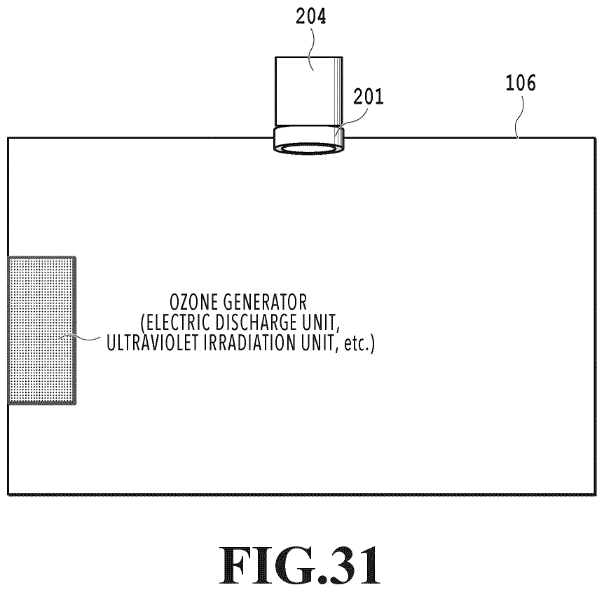

A recovery mechanism was configured such that an ozone generator was provided in the recovery mechanism, the ozone concentration in the space in the recovery container was increased, and it was made possible to directly irradiate generated liquid droplets with ozone as shown in FIG. 31 in Example 34. A liquid containing fine bubbles was manufactured in the same manner as in Example 34 except for these.

The ozone generator is not particularly limited, and any unit can be used. Specifically, although a manufacturing unit using ultraviolet ray irradiation (a low pressure mercury lamp or a Xe excimer lamp having quartz pipe glass, or the like), an electric discharge unit, or the like can be used, a low pressure mercury lamp (output 5 W) having a wavelength of 172 nm was used in the present Example.

### Example 40

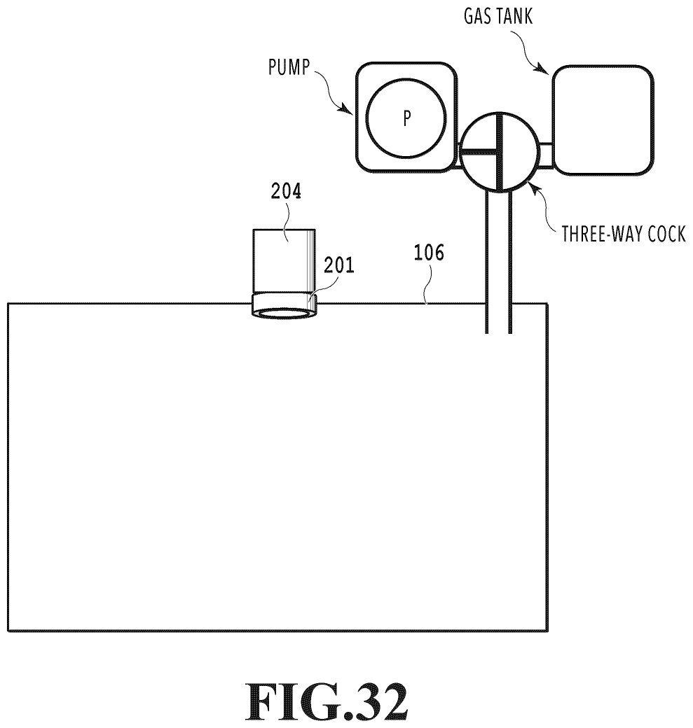

Manufacture was conducted in which the gas component in the manufacturing device of the closed system was replaced with oxygen in Example 34. The manufacturing device shown in FIG. 32 was used for the replacement with oxygen, in which in the state where the valve in the recovery container was open, degassing with reduced pressure was conducted by using the pump, and thereafter, the gas component of the manufacturing device of the closed system was replaced with oxygen from the gas tank filled with oxygen by rotating the three-way cock.

A liquid containing fine bubbles was manufactured in the same manner as in Example 34 except for the above-described change.

### Example 41

The gas component in the manufacturing device of the closed system was replaced with nitrogen in Example 39, and a liquid containing fine bubbles was manufactured.

### Example 42

The gas component in the manufacturing device of the closed system was replaced with hydrogen in Example 39, and a liquid containing fine bubbles was manufactured.

### Example 43

The gas component in the manufacturing device of the closed system was replaced with argon in Example 39, and a liquid containing fine bubbles was manufactured.

### Example 44

The gas component in the manufacturing device of the closed system was replaced with helium in Example 39, and a liquid containing fine bubbles was manufactured.

### Example 45

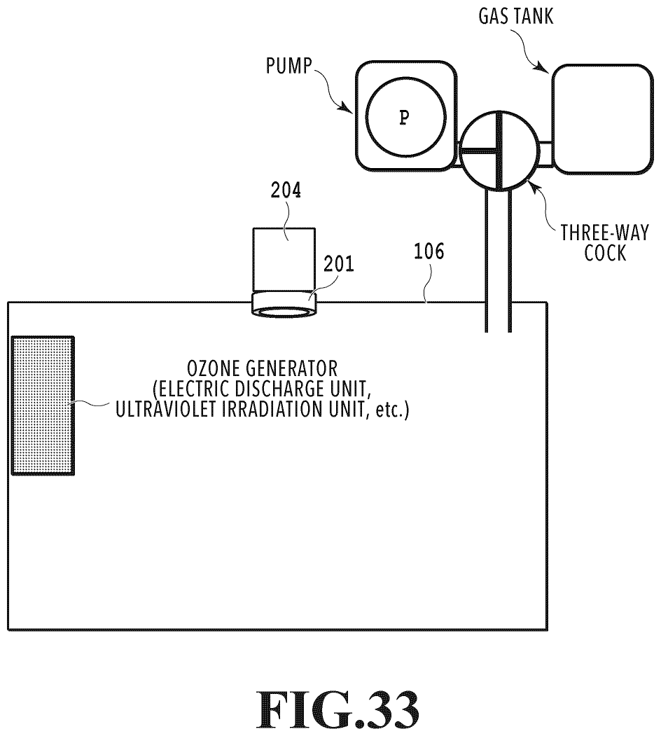

After the gas component in the manufacturing device of the closed system was replaced with oxygen, an ozone space having a high concentration was provided by using an ozone generator, and a liquid containing fine bubbles was manufactured by activating the atomized FB generating device 201 as shown in FIG. 33 in Example 34. Note that although not shown in FIG. 33, the recovery mechanism had a water collecting port, valves, an ozone quencher, and a pump as in FIG. 14.

### Comparative Example 1

It was attempted to recover a liquid containing fine bubbles without providing a recovery mechanism including the recovery container 106 and the like in Example 4 (see FIG. 5). The local relative humidity at a joint portion with a recovery mechanism (which was actually not connected to the recovery container 106) was 81%. Note that the relative humidity in the space in which the liquid was atomized and diffused was 40% in the initial state, and the average relative humidity at the time of the manufacture was 78%. Although the manufacture and recovery of a bulk liquid was attempted by using such a device, the recovery was difficult.

### Comparative Example 2

The height at which a piezoelectric element was set was adjusted such that the distance between the gas-liquid interface and the surface of the piezoelectric element became 30 cm in Example 4. The manufacture of a liquid containing fine bubbles was attempted in the same manner as in Example 4 except for this. Note that in the liquid-gas interface, the formation of a water column and the opacification of the gas phase were not observed.

### Comparative Example 3

The piezoelectric element was changed to a probe type of 267 Hz in Example 4. The manufacture of a liquid containing fine bubbles was attempted in the same manner as in Example 4 except for that. Note that in the liquid-gas interface, the formation of a water column and the opacification of the gas phase were not observed.

### Comparative Example 4 and Comparative Example 5

A fine bubble-containing liquid manufacturing device covered with the recovery container 106 having an atmosphere communication port as in FIG. 22 was used, and further, a bubble-size reducing device which was connected to an exhaust port of an air pump was provided in a water tank bottom portion, in Example 4. Specifically, a gas phase and a water phase separated by using a micropore membrane in between, a pressure on the gas phase side was increased by using the air pump, and the air was introduced through the micropore to prepare an air-containing UFB liquid. As the micropore membrane, a filtration membrane having a molecular weight cut off of 1000 (Minimate manufactured by PALL Corporation) was used. Moreover, an electrolysis-type ozone generating device (Ozone Buster manufactured by Kansai Automation Equipment Co., Ltd.) was provided in the liquid in the water tank.

By using the above-described device, a device for manufacture and dissolution of ozone through electrolysis, mixing of minute bubbles of a sub-micron size through reduction in size of bubbles from an air pump, and atomization and diffusion through irradiation with an ultrasonic wave was manufactured experimentally. Then, by using this device, derivation of the concentration of dissolved ozone and the UFB concentration in the liquid containing fine bubbles as well as identification of properties of the liquid containing fine bubbles were conducted.

In Comparative Example 4, a liquid containing fine bubbles which was manufactured by using water retained in the device in the state where 50% was sprayed for the water loaded before the operation was evaluated. In Comparative Example 5, 40% of water loaded before the operation was sprayed into an indoor space, and recovery and evaluation of a bulk liquid were attempted by recovering the mist. In Comparative Example 4, the production efficiency of UFB, the stable productivity, and the dissolved ozone concentration stability were insufficient. In addition, in Comparative Example 5, the recovery of a bulk liquid was difficult in the first place.

Tables in which Examples and Comparative Examples described above are summarized are described below.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| UFB | 70 | 70 | 70 | 70 | 10 | 10 | 28 | 9 |
| concentration | | | | | | | | |
| (100 million/ml) | | | | | | | | |
| UFB particle | 150 | 130 | 135 | 140 | 110 | 108 | 113 | 89 |
| diameter (nm) | | | | | | | | |
| Proportion of | 99 | 99 | 99 | 99 | 99 | 99 | 99 | 99 |
| UFB in FB: | | | | | | | | |
| 99% or more | | | | | | | | |
| UFB particle | 3.3 | 2.2 | 2.2 | 2.2 | 4 | 2.5 | 7 | 5 |
| diameter | | | | | | | | |
| distribution | | | | | | | | |
| (dw/dn) | | | | | | | | |
| Oxygen | 8.3 | 8.3 | 8.3 | 8.3 | 8.3 | 8.3 | 8.3 | 8.3 |
| concentration | | | | | | | | |
| (ppm) | | | | | | | | |
| Nitrogen | 14 | 14 | 14 | 14 | 14 | 14 | 14 | 14 |
| concentration | | | | | | | | |
| (ppm) | | | | | | | | |
| Ozone | 0 | 0 | 0 | 0 | 28 | 0 | 0 | 0 |
| concentration | | | | | | | | |
| (ppm) | | | | | | | | |
| UFB storage | A | A | A | A | B | A | B | B |
| stability | | | | | | | | |
| Production | A | A | A | A | A | A | A | A |
| efficiency | | | | | | | | |
| Stable | A | A | A | A | A | A | A | A |
| productivity | | | | | | | | |
| Dissolved ozone | nd | nd | nd | nd | B | nd | nd | nd |
| concentration | | | | | | | | |
| stability | | | | | | | | |
| Sterilization | nd | nd | nd | nd | A | nd | nd | A |
| effect | | | | | | | | |

TABLE 2

| | Example | Example | Example | Example | Example | Example | Example | Example |
|---|---|---|---|---|---|---|---|---|
| | 9 | 10 | 11 | 12 | 13 | 14 | 15 | 16 |
| UFB | 10 | 8 | 46 | 46 | 46 | 46 | 46 | 46 |
| concentration | | | | | | | | |
| (100 million/ml) | | | | | | | | |
| UFB particle | 120 | 120 | 130 | 130 | 130 | 130 | 130 | 130 |
| diameter (nm) | | | | | | | | |
| Proportion of | 99 | 99 | 99 | 99 | 99 | 99 | 99 | 99 |
| UFB in FB: | | | | | | | | |
| 99% or more | | | | | | | | |
| UFB particle | 3.3 | 3.4 | 2.5 | 2.5 | 2.5 | 2.5 | 2.5 | 2.5 |
| diameter | | | | | | | | |
| distribution | | | | | | | | |
| (dw/dn) | | | | | | | | |
| Oxygen | 8.3 | 8.3 | 8.3 | 8.3 | 8.3 | 8.3 | 8.3 | 8.3 |
| concentration | | | | | | | | |
| (ppm) | | | | | | | | |
| Nitrogen | 14 | 14 | 14 | 14 | 14 | 14 | 14 | 14 |
| concentration | | | | | | | | |
| (ppm) | | | | | | | | |
| Ozone | 0 | 0 | 0 | 0 | 0 | 0 | 0 | 0 |
| concentration | | | | | | | | |
| (ppm) | | | | | | | | |
| UFB storage | B | B | A | A | A | A | A | A |
| stability | | | | | | | | |
| Production | A | A | A | A | A | A | A | A |
| efficiency | | | | | | | | |
| Stable | A | A | B | A | A | A | A | B |
| productivity | | | | | | | | |
| Dissolved ozone | nd | nd | nd | nd | nd | nd | nd | nd |
| concentration | | | | | | | | |
| stability | | | | | | | | |
| Sterilization | nd | nd | nd | nd | nd | nd | nd | nd |
| effect | | | | | | | | |

TABLE 3

| | Example | Example | Example | Example | Example | Example | Example | Example |
|---|---|---|---|---|---|---|---|---|
| | 17 | 18 | 19 | 20 | 21 | 22 | 23 | 24 |
| UFB | 46 | 12 | 60 | 60 | 60 | 60 | 60 | 60 |
| concentration | | | | | | | | |
| (100 million/ml) | | | | | | | | |
| UFB particle | 130 | 130 | 112 | 112 | 112 | 112 | 112 | 112 |
| diameter (nm) | | | | | | | | |
| Proportion of | 99 | 99 | 99 | 99 | 99 | 99 | 99 | 99 |
| UFB in FB: | | | | | | | | |
| 99% or more | | | | | | | | |
| UFB particle | 2.5 | 3.2 | 3 | 3 | 3 | 3 | 3 | 3 |
| diameter | | | | | | | | |
| distribution | | | | | | | | |
| (dw/dn) | | | | | | | | |
| Oxygen | 8.3 | 8.3 | 4 | 8.3 | 36 | 16.2 | 4 | 4 |
| concentration | | | | | | | | |
| (ppm) | | | | | | | | |
| Nitrogen | 14 | 14 | nd | 14 | 1.2 | 4 | nd | nd |
| concentration | | | | | | | | |
| (ppm) | | | | | | | | |
| Ozone | 0 | 15 | 0 | 0 | 0 | 0 | 0 | 0 |
| concentration | | | | | | | | |
| (ppm) | | | | | | | | |
| UFB storage | A | A | A | A | A | A | A | A |
| stability | | | | | | | | |
| Production | A | A | A | A | A | A | A | A |
| efficiency | | | | | | | | |
| Stable | A | A | A | A | A | A | A | A |
| productivity | | | | | | | | |
| Dissolved ozone | nd | B | nd | nd | nd | nd | nd | nd |
| concentration | | | | | | | | |
| stability | | | | | | | | |
| Sterilization | nd | A | nd | nd | nd | nd | nd | nd |
| effect | | | | | | | | |

TABLE 4

| | Example | Example | Example | Example | Example | Example | Comparative | Comparative |
|---|---|---|---|---|---|---|---|---|
| | 25 | 26 | 27 | 28 | 29 | 30 | Example 1 | Example 2 |
| UFB | 12 | 12 | 12 | 10 | 14 | 13 | nd | 1 |
| concentration | | | | | | | | |
| (100 million/ml) | | | | | | | | |
| UFB particle | 130 | 130 | 130 | 140 | 132 | 134 | nd | 110 |
| diameter (nm) | | | | | | | | |
| Proportion of | 99 | 99 | 99 | 99 | 99 | 99 | | 99 |
| UFB in FB: | | | | | | | | |
| 99% or more | | | | | | | | |
| UFB particle | 3.2 | 3.2 | 3.2 | 3.6 | 2.1 | 2.3 | nd | 3.4 |
| diameter | | | | | | | | |
| distribution | | | | | | | | |
| (dw/dn) | | | | | | | | |
| Oxygen | 8.3 | 8.3 | 8.3 | 8.3 | 8.3 | 8.3 | nd | 8.3 |
| concentration | | | | | | | | |
| (ppm) | | | | | | | | |
| Nitrogen | 14 | 14 | 14 | 14 | 14 | 14 | nd | 14 |
| concentration | | | | | | | | |
| (ppm) | | | | | | | | |
| Ozone | 0 | 33 | 38 | 0 | 0 | 0 | nd | 0 |
| concentration | | | | | | | | |
| (ppm) | | | | | | | | |
| UFB storage | A | A | A | B | A | A | nd | C |
| stability | | | | | | | | |
| Production | A | A | A | A | A | A | nd | A |
| efficiency | | | | | | | | |
| Stable | A | A | A | A | A | A | D | D |
| productivity | | | | | | | | |
| Dissolved ozone | nd | A | A | nd | nd | nd | nd | nd |
| concentration | | | | | | | | |
| stability | | | | | | | | |
| Sterilization | nd | A | A | nd | nd | nd | nd | nd |
| effect | | | | | | | | |

TABLE 5

| | Example | Example | Example | Example | Example | Example | Example | Example |
|---|---|---|---|---|---|---|---|---|
| | 31 | 32 | 33 | 34 | 35 | 36 | 37 | 38 |
| UFB | 10 | 12 | 13 | 14 | 14 | 14 | 14 | 14 |
| concentration | | | | | | | | |
| (100 million/ml) | | | | | | | | |
| UFB particle | 108 | 111 | 110 | 105 | 105 | 105 | 105 | 105 |
| diameter (nm) | | | | | | | | |
| Proportion of | 99 | 99 | 99 | 99 | 99 | 99 | 99 | 99 |
| UFB in FB: | | | | | | | | |
| 99% or more | | | | | | | | |
| UFB particle | 2.5 | 2.5 | 2.5 | 2.5 | 2.5 | 2.5 | 2.5 | 2.5 |
| diameter | | | | | | | | |
| distribution | | | | | | | | |
| (dw/dn) | | | | | | | | |
| Oxygen | 8.3 | 8.3 | 8.3 | 8.3 | 8.3 | 8.3 | 8.3 | 8.3 |
| concentration | | | | | | | | |
| (ppm) | | | | | | | | |
| Nitrogen | 14 | 14 | 14 | 14 | 14 | 14 | 14 | 14 |
| concentration | | | | | | | | |
| (ppm) | | | | | | | | |
| Ozone | 0 | 0 | 0 | 0 | 0 | 0 | 0 | 0 |
| concentration | | | | | | | | |
| (ppm) | | | | | | | | |
| UFB storage | A | A | A | A | A | A | A | A |
| stability | | | | | | | | |
| Production | A | A | A | A | A | A | A | A |
| efficiency | | | | | | | | |
| Stable | A | A | A | A | A | A | A | A |
| productivity | | | | | | | | |
| Dissolved ozone | nd | nd | nd | nd | nd | nd | nd | nd |
| concentration | | | | | | | | |
| stability | | | | | | | | |
| Sterilization | nd | nd | nd | nd | nd | nd | nd | nd |
| effect | | | | | | | | |

TABLE 6

| | Example | Example | Example | Example | Example | Example | Example |
|---|---|---|---|---|---|---|---|
| | 39 | 40 | 41 | 42 | 43 | 44 | 45 |
| UFB | 14 | 14 | 14 | 14 | 14 | 14 | 14 |
| concentration | | | | | | | |
| (100 million/ml) | | | | | | | |
| UFB particle | 105 | 105 | 105 | 112 | 112 | 112 | 130 |
| diameter (nm) | | | | | | | |
| Proportion of | 99 | 99 | 99 | 99 | 99 | 99 | 99 |
| UFB in FB: | | | | | | | |
| 99% or more | | | | | | | |
| UFB particle | 3.2 | 3 | 3 | 3 | 3 | 3 | 3.2 |
| diameter | | | | | | | |
| distribution | | | | | | | |
| (dw/dn) | | | | | | | |
| Oxygen | 8.3 | 36 | 16.2 | 4 | 4 | 4 | 4 |
| concentration | | | | | | | |
| (ppm) | | | | | | | |
| Nitrogen | 14 | 1.2 | 4 | nd | nd | nd | nd |
| concentration | | | | | | | |
| (ppm) | | | | | | | |
| Ozone | 15 | 0 | 0 | 0 | 0 | 0 | 100 |
| concentration | | | | | | | |
| (ppm) | | | | | | | |
| UFB storage | A | A | A | A | A | A | A |
| stability | | | | | | | |
| Production | A | A | A | A | A | A | A |
| efficiency | | | | | | | |
| Stable | A | A | A | A | A | A | A |
| productivity | | | | | | | |
| Dissolved ozone | A | nd | nd | nd | nd | nd | A |
| concentration | | | | | | | |
| stability | | | | | | | |
| Sterilization | A | nd | nd | nd | nd | nd | A |
| effect | | | | | | | |

The present disclosure makes it possible to efficiently manufacture fine bubbles.

### List of Patent Literature

PTL 1: Japanese Patent No. 6118544
PTL 2: Japanese Patent No. 4456176
PTL 3: Japanese Patent Laid-Open No. 2018-65124
PTL 4: Japanese Patent Laid-Open No. 2015-116555

The present disclosure is not limited to the above-described embodiments, and various changes and modifications are possible without departing from the spirit and scope of the present disclosure. Therefore, the following claims are attached to publicize the scope of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. A manufacturing method for a liquid containing fine bubbles, comprising:
a generation step of generating liquid droplets containing fine bubbles by atomizing a liquid through irradiation with an ultrasonic wave; and
a recovery step of recovering the liquid droplets into a recovery container by using a recovery mechanism including the recovery container.

2. The manufacturing method according to claim 1, wherein inside the recovery container, an average value of relative humidity during manufacture of the liquid containing fine bubbles is 80% or more, where an average value of a relative humidity while the liquid has condensed is regarded as 100%.

3. The manufacturing method according to claim 1, wherein in the generation step, a vibrator for irradiating the liquid retained in a liquid tank with the ultrasonic wave is used.

4. The manufacturing method according to claim 3, wherein a thickness of the liquid on the vibrator is 15 cm or less.

5. The manufacturing method according to claim 3, wherein the liquid tank is provided with a liquid introduction passage for guiding the liquid onto a surface of the vibrator through capillary action.

6. The manufacturing method according to claim 3, wherein
a float is attached to the vibrator, and
the vibrator is floated in the liquid.

7. The manufacturing method according to claim 3, wherein in the recovery step, the liquid droplets come into contact with an intermedium included in the recovery mechanism, so that the liquid droplets are recovered into the recovery container.

8. The manufacturing method according to claim 7, wherein the intermedium has a net structure in part.

9. The manufacturing method according to claim 8, wherein a pore diameter of a net of the net structure is 1 mm or more.

10. The manufacturing method according to claim 3, wherein
a fan is attached to the recovery container, and
in the recovery step, the liquid droplets come into contact with the fan being rotated, so that the liquid droplets are recovered into the recovery container.

11. The manufacturing method according to claim 3, wherein
a blast fan, a liquid supply tank, a liquid column growth suppressing plate, and a water level sensor are attached to the liquid tank,
the recovery mechanism includes: an exhaust fan which is connected to the recovery container through a fractionating tube; and a water collecting port attached to the recovery container, and
the liquid tank and the recovery container are connected through a fractionating tube.

12. The manufacturing method according to claim 3, wherein the recovery mechanism includes a pump, a gas tank, and a three-way cock for adjusting a gas component and a partial pressure inside the recovery container to recover the liquid droplets.

13. The manufacturing method according to claim 3, wherein the recovery mechanism is in a closed system in which exchange of a substance with an outside is restricted.

14. The manufacturing method according to claim 13, wherein
the recovery mechanism includes a water collecting port, a valve, an ozone quencher, and a pump, and
an ozone generator is attached inside the recovery container.

15. The manufacturing method according to claim 14, wherein the ozone generator includes a unit for emitting the ultraviolet ray.

16. The manufacturing method according to claim 3, wherein
the liquid tank is covered with the recovery container, and
a water collecting port is attached to the recovery container.

17. The manufacturing method according to claim 16, wherein
a wall of the recovery container has flexibility.

18. The manufacturing method according to claim 3, wherein
the liquid tank is provided with a pump, a gas tank, a three-way cock, and an agitating unit, and
the recovery mechanism includes a pump, a gas tank, and a three-way cock, and a water collecting port for adjusting a gas component and a partial pressure inside the recovery container to recover the liquid droplets.

19. The manufacturing method according to claim 3, wherein a liquid tank to which the liquid is supplied in the generation step and the recovery mechanism are integrated.

20. The manufacturing method according to claim 1, wherein
in the generation step, a vibrator for irradiating a first liquid retained in a liquid tank with the ultrasonic wave is used, and
by directly irradiating the first liquid with the ultrasonic wave to indirectly irradiate a second liquid which is different from the first liquid, the second liquid is atomized.

21. The manufacturing method according to claim 1, wherein
the recovery mechanism includes a reservoir chamber for the liquid and a generating device which generates atomized fine bubbles,
the generating device includes a mesh and a vibrator, and
in the generation step, the liquid is supplied to the mesh, and the supplied liquid is irradiated with the ultrasonic wave by the vibrator.

22. The manufacturing method according to claim 21, wherein in the recovery step, the liquid droplets come into contact with the recovery mechanism, so that the liquid droplets are recovered into the recovery container.

23. The manufacturing method according to claim 21, wherein
the generating device includes the mesh on an upper surface thereof, and
the generating device is laterally installed, and a direction in which the liquid droplets are generated is a lateral direction.

24. The manufacturing method according to claim 23, wherein the generating device has a cylindrical shape.

25. The manufacturing method according to claim 21, wherein
the generating device includes the mesh on an upper surface thereof, and
the generating device is installed downward, and a direction in which the liquid droplets are generated is a downward direction.

26. The manufacturing method according to claim 25, wherein the generating device has a cylindrical shape.

27. The manufacturing method according to claim 21, wherein the recovery mechanism is in a closed system in which exchange of a substance with an outside is restricted.

28. The manufacturing method according to claim 21, wherein
the recovery mechanism includes a water collecting port, a valve, an ozone quencher, and a pump, and
an ozone generator is attached inside the recovery container.

29. The manufacturing method according to claim 28, wherein the ozone generator includes a unit for emitting the ultraviolet ray.

30. The manufacturing method according to claim 21, wherein
the reservoir chamber is covered with the recovery container, and
a water collecting port is attached to the recovery container.

31. A manufacturing device for a liquid containing fine bubbles, comprising:
a generating unit for generating liquid droplets containing fine bubbles by atomizing a liquid through irradiation with an ultrasonic wave; and
a recovery mechanism for recovering the liquid droplets into a recovery container.
